(19) United States
(12) Patent Application Publication
(10) Pub. No.: US 2017/0332125 A1
(43) Pub. Date: Nov. 16, 2017

(54) SYSTEMS AND METHODS FOR NOTIFYING DIFFERENT USERS ABOUT MISSED CONTENT BY TAILORING CATCH-UP SEGMENTS TO EACH DIFFERENT USER

(71) Applicant: Rovi Guides, Inc., San Carlos, CA (US)

(72) Inventors: Vishwas Sharadanagar Panchaksharaiah, Bangalore (IN); Vikram Makam Gupta, Bangalore (IN)

(21) Appl. No.: 15/200,194

(22) Filed: Jul. 1, 2016

Related U.S. Application Data
(60) Provisional application No. 62/334,202, filed on May 10, 2016.

(51) Int. Cl. H04N 21/262; H04N 21/482; H04N 21/4415; H04N 21/218; H04N 21/4223; H04N 21/234; H04N 21/2187; H04N 21/488; H04N 21/45

(52) U.S. Cl. CPC H04N 21/26283; H04N 21/4882; H04N 21/4826; H04N 21/4821; H04N 21/4532; H04N 21/21805; H04N 21/4223; H04N 21/23418; H04N 21/2187; H04N 21/4415

(57) ABSTRACT

Systems and methods are described herein for providing a media guidance application that reduces an amount of time required to catch a user up to live media by selectively presenting to the user portions of important content that the user finds most important. For example, a first user and a second user may wish to catch-up on a mutually missed portion of media. Both users may be notified about an important event in the media. If the first user is a fan of a first actor in the media, the first user will be presented a description of the missed portion in relation the first actor. If the second user is a fan of a second actor in the media, the second user will be presented a description of the missed portion in relation the second actor. Therefore, each respective user, will catch-up on content from the missed portion that he or she respectively finds most important.

This application claims the benefit of United States Provisional Application No. 62/334,202, filed May 10, 2016, the disclosure of which is hereby incorporated by reference herein in its entirety.

### BACKGROUND

In conventional systems, a user can record and playback content that they may miss. Oftentimes, a user may miss a portion of live media and may wish to catch-up to the live media as soon as possible. Conventional systems can present a “highlight reel” to the user, which highlights important events in the media so that the user can view the important events (e.g., a touchdown in a football game) and skip events that are not important (e.g., commercials during a timeout). However, the user may waste his or her time by viewing portions of the important events that are not of interest to the user. Furthermore, the user may be forced to view the catch-up content before he or she can return to the live media, thus causing the user to miss out on further live content.

### SUMMARY

Systems and methods are described herein for providing a media guidance application that reduces an amount of time required to catch a user up to live media by selectively presenting to the user portions of objectively important content that the user also will subjectively find important. For example, a first user and a second user may wish to catch-up on a missed portion of a Giants v. Jets football game. Both users may be notified about a Giants touchdown that occurred during a portion missed by both users. The media guidance application may determine that the first user is a Giants fan and may catch-up the first user to the live media by presenting the first user with an image showing a Giants player scoring the touchdown. In contrast, the media guidance application may determine that the second user is a Jets fan and may catch-up the second user to the live media by presenting the second user with an image of a Jets player missing a tackle during the touchdown. Therefore, the media guidance application tailors, to each respective user, different content from the missed portion that he or she respectively finds most important.

In some aspects, the media guidance application may notify different users about content from live video that the different users missed by tailoring important catch-up segments to each different user. For example, the media guidance application may determine that a first user and a second user missed a goal scored during a soccer game. The media guidance application may determine that a first player scored the goal and that the first player is on the first user's fantasy sports team. Consequentially, the media guidance application may tailor the catch-up segment to the first user by describing how the goal scored by the first player will affect the first user's fantasy sports ranking. In contrast, the media guidance application may determine that a second player that assisted the first player in scoring the goal is on the second user's fantasy sports roster. The media guidance application may tailor the catch-up segment to the second user by describing how the assist by the second player will affect the second user's fantasy sports roster.

In some aspects, the media guidance application may determine, during a first period, that a first user and a second user are disregarding a portion of live video corresponding to the first period. For example, the media guidance application may detect that the first user and the second user are talking to each other during a first period by measuring an amount of ambient sound in a room.

The media guidance application may determine when the amount of ambient sound is greater than a threshold amount of ambient sound that the users are disregarding the portion.

In some embodiments, the media guidance application may determine that the first user and the second user are disregarding the media based on a gaze point of the first and of the second user. For example, the media guidance application may generate for display the live video on first user equipment, such as a television. The media guidance application may detect, using a camera associated with the first user equipment, a first gaze point corresponding to the first user and a second gaze point corresponding to the second user relative to the first user equipment. For example, the media guidance application may detect an eye position associated with the first user and an eye position associated with the second user and may determine, based on the eye positions, whether the first user and the second user are looking at the first user equipment, for example, a television. The media guidance application may determine that the first user an the second user are disregarding the live video in response to determining that the first gaze point and the second gaze point do not correspond to the first user equipment. For example, the media guidance application may determine that the first and the second user are disregarding the live media when the media guidance application determines that the users are not looking at the television (e.g., first user equipment).

In some embodiments, the media guidance application may determine that the first user and the second user are disregarding the portion of live video when the users are outside of a range of the first user equipment (e.g., television). For example, the media guidance application may determine that the first user and the second user are disregarding the portion when a second user equipment device corresponding to the first user (e.g., a smartphone of the first user) and a third user equipment device corresponding to the second user (e.g., a smartphone of the second user) are outside of a wireless communication range of the first user equipment (e.g., television). For example, the media guidance application may identify the second user equipment associated with the first user and the third user equipment associated with the second user based on the respective first and second profile data (e.g., the media guidance application may determine that the second device and the third device are linked to the first and second user profile, respectively).

In some embodiments, the media guidance application may determine, at a first time, before the first period, that the second user equipment and the third user equipment are within a threshold maximum distance from the first user equipment. For example, the media guidance application may approximate a distance between the first user equipment and the second and third user equipment, using a first signal strength of a wireless connection (e.g., Bluetooth connection) between the first and second user equipment and a second signal strength of a wireless connection between the first and third user equipment. The media guidance application may determine that the second and third user equipment are within the threshold maximum distance based on the approximation. The media guidance application may determine, at a second time, during the first period, that the second user equipment and the third user equipment are greater than the threshold maximum distance away from the first user equipment. For example, the media guidance application may determine that the second user equipment and the third user equipment are greater than the threshold distance based on a signal strength (e.g., Bluetooth connection strength) from each respective device as described above. The media guidance application may determine that the first user and the second user are disregarding the live video at the second time in response to determining that the second user equipment and the third user equipment are greater than the threshold maximum distance away from the first user equipment. For example, the media guidance application may determine that when the second and third user equipment are farther than the threshold distance that the first and the second user cannot see the live video and are therefore disregarding it.

In some aspects, the media guidance application may identify a micro-portion of the portion of live video that corresponds to an important event in the live video. For example, the media guidance application may retrieve data (e.g., metadata associated with a video stream for the live video) identifying important portions of media. For example, the media guidance application may detect that frames of the live video are numbered. The media guidance application may determine, based on the metadata, that an important portion begins at frame number N and ends at frame number N+2000 in the live video. The media guidance application may select frames N to N+2000 as a micro-portion corresponding to an important event in the live video.

In some embodiments, the media guidance application may identify the micro-portion corresponding to the important event in the live media by determining a respective type of each micro-portion of the portion. For example, the media guidance application may determine that a first micro-portion corresponds to a touchdown in a football game and may determine that a second micro-portion corresponds to a five yard running play in the football game. The media guidance application may retrieve, from a database, a set of popular types of micro-portions. For example, the media guidance may determine, based on the set of popular types, that a touchdown is a popular type but a five yard running play is not a popular type because a touchdown may affect a team's chance of winning greater than a five yard running play. The media guidance application may compare each type from the set of popular types to determine whether a micro-portion of the portion matches a popular type from the set. For example, the media guidance application may compare the type of each micro-portion from a portion of live media (e.g., portion of live media missed by a user) to the types from the set and may determine that the micro-portion corresponds to an important event in the live video if the type of the micro-portion matches a type from the set (e.g., if the micro-portion corresponds to a touchdown the media guidance application may determine that the micro-portion is important, but if the micro-portion corresponds to a five yard running play the media guidance application may determine that the micro-portion is not important).

In some embodiments, the media guidance application may identify the micro-portion corresponding to the important event in the live media based on performing image processing on the frames of the portion of the live media. The media guidance application may retrieve a frame of the live video generated for display during the portion. For example, the media guidance application may retrieve a frame of the live video corresponding to a portion of the live video that is missed by the first user. The media guidance application may analyze the frame using an image processing algorithm to determine whether the frame matches an image processing rule. For example, the media guidance application may analyze the first frame to determine whether there is fast action during the frame, a score change during the frame, etc. The media guidance application may determine that the frame corresponds to the important event when the frame matches the image processing rule. For example, the media guidance application may determine that the frame is important when the media guidance application detects a score change in the frame.

In some aspects, the media guidance application may retrieve a first profile of a first user and a second profile of a second user from memory. For example, the media guidance application may query a remote database (e.g., using network connection of the media guidance application) for profile data associated with a first user and profile data associated with the second user. The media guidance application may request respective user profile data corresponding to characteristics that the respective users deem important in media (e.g., favorite sports teams, favorite actors/actresses, media viewing history, etc.).

In some aspects, the media guidance application may determine, based on data of the first profile, a first criterion characterizing content that is important to the first user. For example, the media guidance application may determine that the first user is watching a sports game. The media guidance application may retrieve data from the first user profile identifying the first user's favorite sports teams.

The media guidance application may determine, based on the data, that the first user is a New York Giants fan, and may resultantly determine that the first criterion is whether the media includes a New York Giants player.

In some aspects, the media guidance application may determine, based on data of the second profile, a second criterion characterizing content that is important to the second user and is different from the first criterion. For example, the media guidance application may retrieve data from the second user profile listing that New York Jets games are most frequently watched by the second user. The media guidance application may determine that the second criterion is whether the media includes a New York Jets player based on the determination that the user frequently watches New York Jets games. The media guidance application may determine a second criterion different from the first criterion when the second profile data is different from the first profile data (e.g., when the media guidance application determines that the first user and the second user have different preferences).

In some aspects, the media guidance application may retrieve data corresponding to the micro-portion. For example, the media guidance application may receive, in data associated with the live video stream, a description of events occurring in the micro-portion. For example, the media guidance application retrieve data identifying a touchdown scored in the micro-portion. The media guidance application may retrieve data from a database comprising information related to the touchdown, such as statistics for players who were involved in the touchdown play. Following from the previous example, the media guidance application may determine, based on the retrieved data that the micro-portion corresponds to a touchdown scored by the New York Giants in a football game verses the New York Jets.

In some aspects, the media guidance application may identify, based on the retrieved data corresponding to the micro-portion, a first frame of the micro-portion matching the first criterion and a second frame of the micro-portion matching the second criterion, wherein the second frame is different from the first frame. Following from the previous example, the media guidance application may identify a first frame corresponding to a New York Giants player that scored the touchdown and may identify a second frame corresponding to a New York Jets player that missed a tackle during the touchdown play. As an example, the media guidance application may use an image processing algorithm to identify football players in the micro-portion. The media guidance application may determine that a first frame comprising a New York Giants player matches the first criterion (e.g., frame associated with a New York Giants player) and a second frame comprising a New York Jets player matches the second criterion (e.g., frame associated with a New York Jets player).

In some embodiments, the media guidance application may identify the first frame of the micro-portion matching the first criterion and the second frame of the micro-portion matching the second criterion by performing object recognition on each frame of the micro-portion. The media guidance application may identify a first plurality of objects associated with the first criterion and a second plurality of objects associated with the second criterion. Following from the previous example, the media guidance application may retrieve from a database a listing of objects, such as jersey numbers, uniform colors, and player numbers associated with the first criterion (e.g., the New York Giants) and identify a second plurality of objects, such as uniform colors and player faces associated with the second criterion (e.g., the New York Jets).

The media guidance application may perform object recognition on each respective frame of the plurality of frames associated with the micro-portion to identify a respective plurality of objects associated with each respective frame. For example, the media guidance application may recognize objects in each frame, such as players recognized based on jersey numbers and colors. The media guidance application may select a first frame in response to determining that the first frame is associated with the first plurality of objects and may select a second frame in response to determining that the second frame is associated with a second plurality of objects. For example, the media guidance application may select a first frame in response to determining that a first frame is associated with a New York Giants player and may select a second frame in response to determining that the second frame is associated with a New York Jets player.

In some embodiments, the media guidance application may identify, from a first plurality of frames associated with the micro-portion, a second plurality of frames each comprising an object matching the first plurality of objects. For example, the media guidance application may select a second plurality of frames from a first plurality of frames associated with the micro-portion each having objects associated with the New York Giants, such as New York Giants players.

The media guidance application may rank each respective frame of the second plurality of frames based on a respective amount of objects in the respective frame matching the first plurality of objects. For example, the media guidance application may rank each frame based on a number of New York Giants players located in each frame of the second plurality of frames.

The media guidance application may select a frame as the first frame in response to determining that the first frame has a highest respective amount of objects matching the first plurality of objects with respect to each frame of the second plurality of frames. For example, the media guidance application may select a frame from the second plurality of frames having New York Giants players having the greatest number of New York Giants players. The media guidance application may select the first frame representing the important content, for example a touchdown scored by the New York Giants.

In some aspects, the media guidance application may generate for display to the first user information associated with the first frame. For example, the media guidance application may generate for display to the first user a textual description of events captured in the frame. In another example, the media guidance application may generate for display to the first user the first frame.

In some aspects, the media guidance application may generate for display to the second user information associated with the second frame. For example, the media guidance application may identify a mobile device, such as a cell phone associated with the second user and may generate for display information associated with the second frame to the second user on the cell phone. In another example, the media guidance application may push a textual update describing content in the second frame to the cell phone.

In some embodiments, the media guidance application may generate for display text corresponding to a largest object in the first frame. The media guidance application may compute a respective amount of pixels corresponding to each object of the first plurality of objects within the first frame. Following from the previous example, the media guidance application may determine an amount of pixels corresponding to each New York Giants player in the first frame. Based on the respective amount of pixels, the media guidance application may identify a largest object, from the plurality of objects, corresponding to a highest respective percentage of pixels. For example, the media guidance application may rank an amount of pixels corresponding to each New York Giants player in the frame and may select the player corresponding to a highest amount of pixels.

The media guidance application may retrieve, from a database, a textual template associated with the largest object. For example, the media guidance application may determine that the largest object is Eli Manning (e.g., a New York Giants quarterback). The media guidance application may retrieve a textual template associated with Eli Manning, such as a textual description of Eli Manning's performance during the touchdown. The media guidance application may generate for display the text describing the largest object based on the retrieved textual template. For example, the media guidance application may generate for display text describing Eli Manning's performance in response to determining that he is the largest object in the frame.

In some embodiments, the media guidance application may generate for display on the second user equipment the information associated with the first frame in response to determining, at a third time later than the second time, that the second user equipment is within the threshold maximum distance away from the first user equipment. For example, the media guidance application may generate for display the first frame when the first user is back within the range of the first user equipment device. Likewise, the media guidance application may generate for display to the second user the second frame when the second user is within the threshold maximum distance away from the first user equipment (e.g., on the first user equipment so that the first user and the second user can catch-up to the live media).

In some embodiments, the media guidance application may generate for display on the second user equipment, at the second time, the information associated with the first frame in response to determining that the second user equipment device is greater than the threshold maximum distance away from the first user equipment. For example, the media guidance application may push a notification comprising the information associated with the first frame to the second user equipment (e.g., the first user's smartphone) when the user is away from the first user equipment (e.g., a set-top box) so that the first user can catch-up to the live media when the first user is away from the first user equipment.

It should be noted that the systems and/or methods described above may be applied to, or used in accordance with, other systems, methods, and/or apparatuses.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of user interaction with a media guidance system in accordance with some embodiments of the disclosure;

FIG. 2 shows an illustrative example of live media played back on user equipment having an overlay of catch-up material directed to a first and a second user in accordance with some embodiments of the disclosure;

FIG. 3 shows an illustrative example of a media guidance display that may be presented in accordance with some embodiments of the disclosure;

FIG. 4 shows another illustrative example of a media guidance display that may be presented in accordance with some embodiments of the disclosure;

FIG. 5 is a block diagram of an illustrative user equipment device in accordance with some embodiments of the disclosure;

FIG. 6 is a block diagram of an illustrative media system in accordance with some embodiments of the disclosure;

FIG. 7 is a flowchart of illustrative steps for notifying different users about missed content by tailoring catch-up content to each different user in accordance with some embodiments of the disclosure;

FIG. 8 is a flow chart of illustrative steps for tailoring catch-up content to a user in accordance with some embodiments of the disclosure.

### DETAILED DESCRIPTION

Systems and methods are described herein for providing a media guidance application that reduces an amount of time required to catch a user up to live media by selectively presenting to the user portions of objectively important content that the user also will subjectively find to be important. In particular, the media guidance application may determine at a first time that a first user and a second user are watching media, such as a Giants v. Jets football game. The media guidance application may track the first and the second user (e.g., by monitoring the first and the second user via an input device, such as a camera accessible to the media guidance application) and may determine that the first and the second user are disregarding the media at a second time. For example, the media guidance application may determine that the first and the second user are looking at their cell phones at the second time and are therefore not observing the football game. While the users are disregarding the media, the media guidance application may determine that an important event occurred in the media (e.g., by determining that the score of the football game changed). In response to determining that an important event occurred in the media while the users were disregarding the media (e.g., the users missed the important event), the media guidance application may generate catch-up content for the first and the second user tailored to the interest of each user. For example, both users may be notified about a Giants touchdown that occurred during a disregarded portion of the football game. The media guidance application may determine that the first user is a Giants fan (e.g., based on user profile data of the first user) and may catch-up the first user to the live media by presenting the first user with an image showing a Giants player scoring the touchdown. In contrast, the media guidance application may determine that the second user is a Jets fan (e.g., based on a viewing history of the second user) and may catch-up the second user to the live media by presenting to the second user an image of a Jets player missing a tackle during the touchdown. The media guidance application may determine that the users are no longer disregarding the live media (e.g., based on input from a biometric sensor accessible to the media guidance application) at a third time and may present the tailored catch-up content to each user along side the live media. Accordingly, each respective user can quickly catch-up to the live media by only viewing portions of the disregarded content that he or she respectively finds most important.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

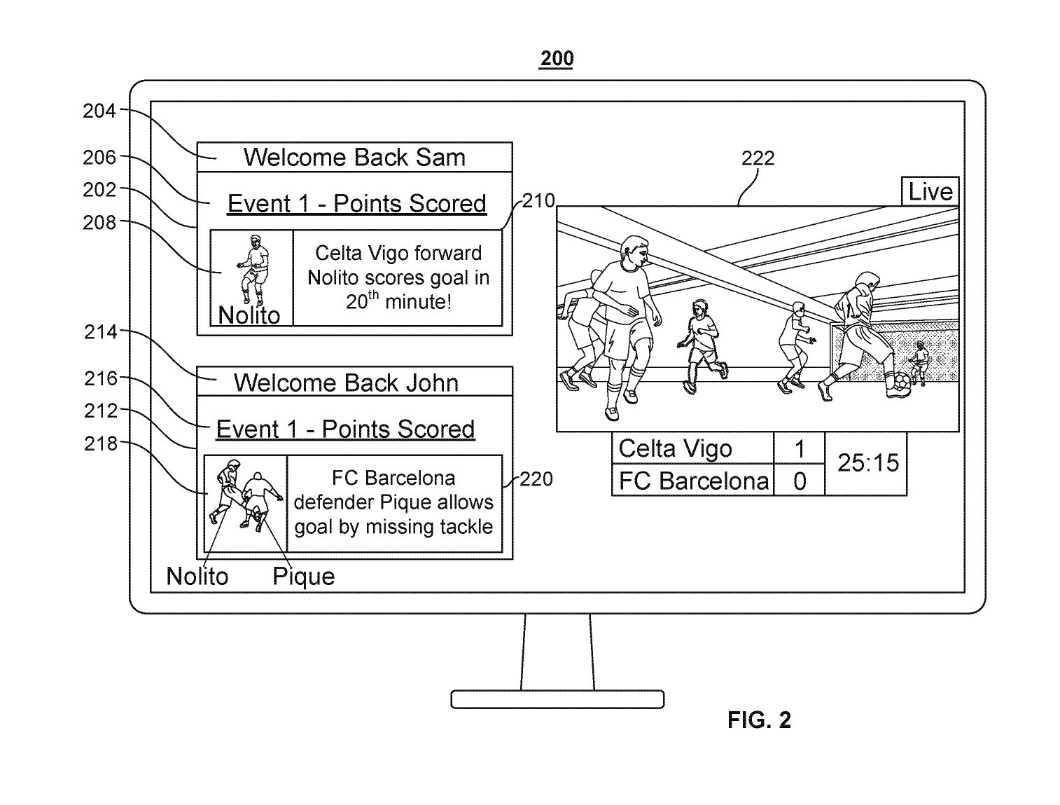

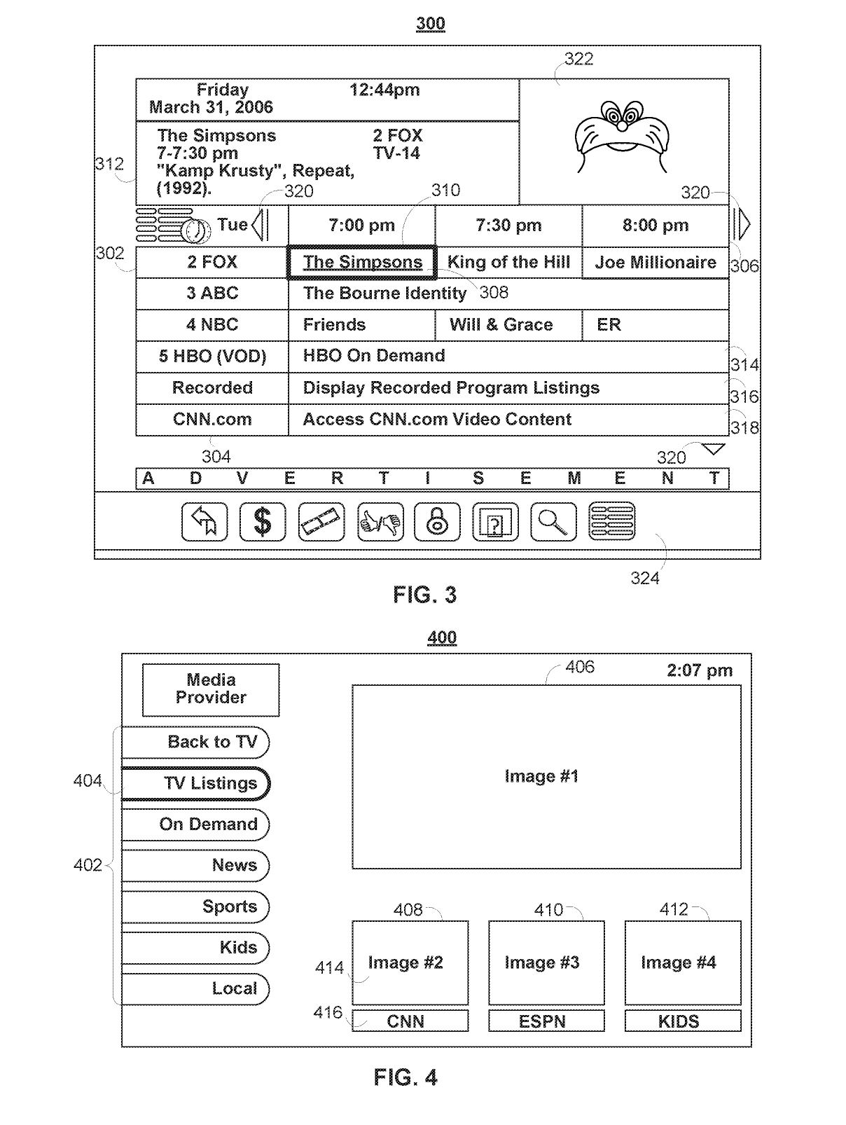

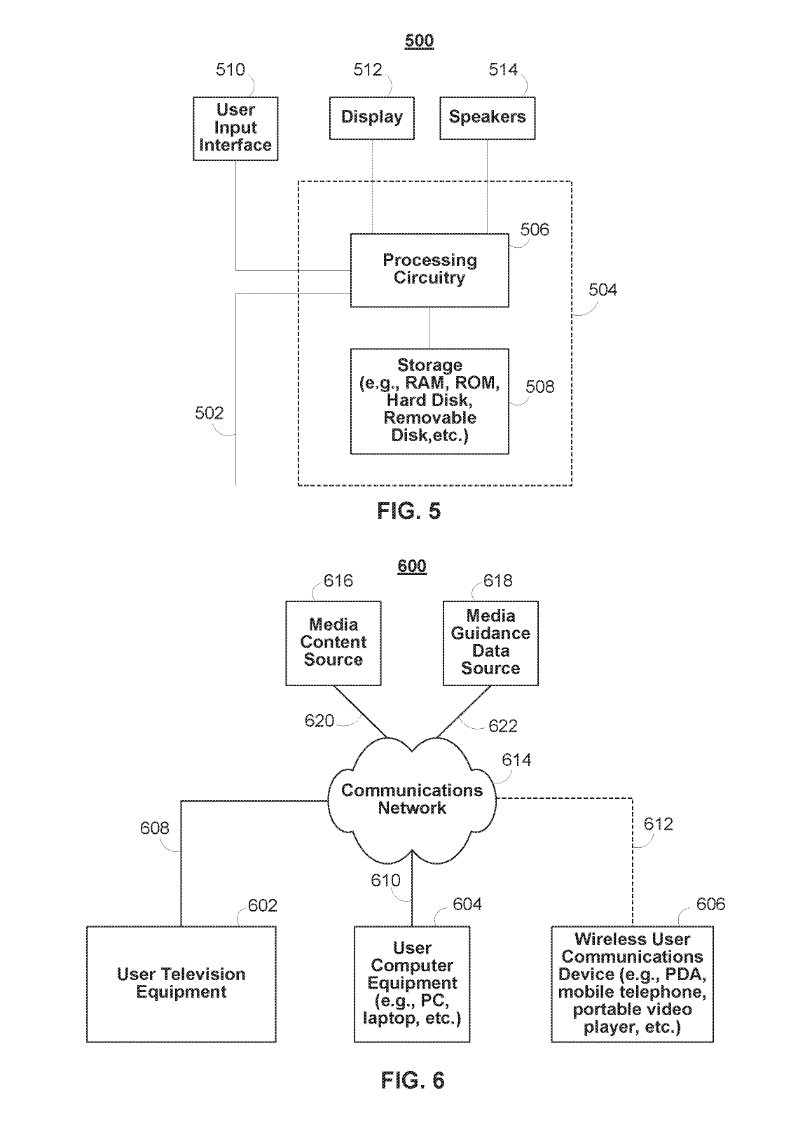

In some embodiments, control circuitry 504, discussed further in relation to FIG. 5 below, executes instructions for a media guidance application stored in memory (i.e., storage 508). Specifically, control circuitry 504 may be instructed by the media guidance application to perform the functions discussed above and below. For example, the media guidance application may provide instructions to control circuitry 504 to generate the media guidance displays discussed in relation to FIG. 2, FIG. 3, and FIG. 4. In some implementations, any action performed by control circuitry 504 may be based on instructions received from the media guidance application.

As referred to herein, the term “in response to” refers to initiated as a result of For example, a first action being performed in response to a second action may include interstitial steps between the first action and the second action.

As referred to herein, the term “directly in response to” refers to caused by. For example, a first action being performed directly in response to a second action may not include interstitial steps between the first action and the second action.

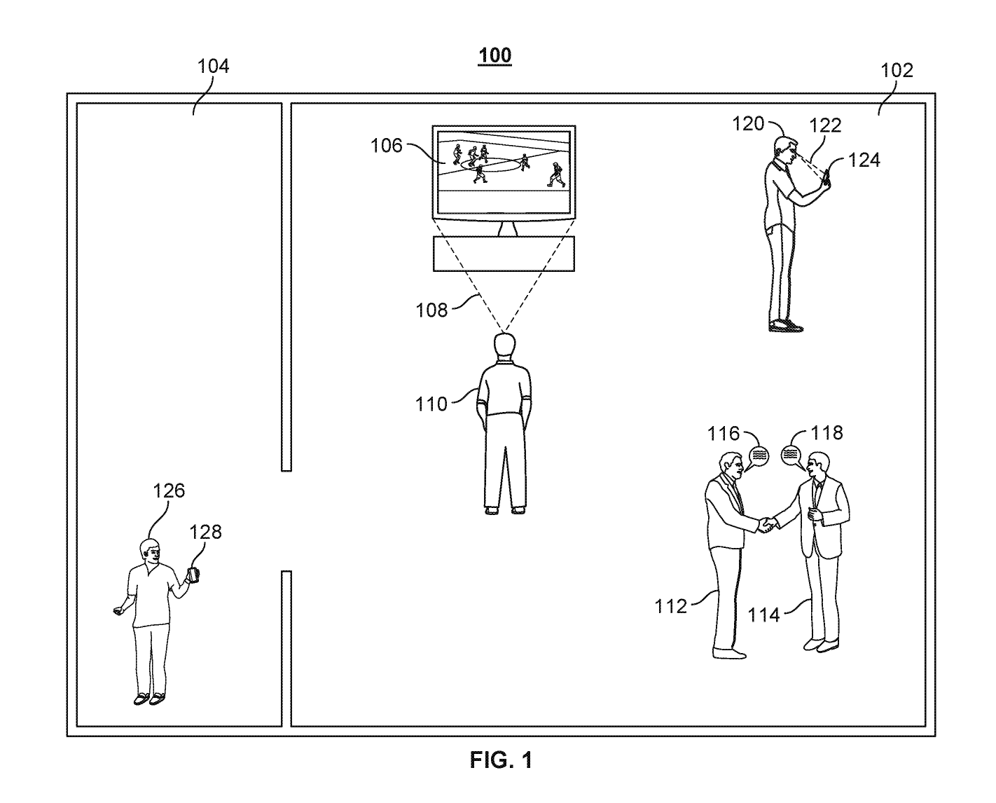

FIG. 1 shows an illustrative embodiment of users detected by a media guidance application, in accordance with some embodiments of the disclosure. Building 100 is depicted as having two rooms, large room 102 and small room 104. Large room 102 is depicted as having user equipment 106 within visual field 108 of user 110. User 120 is depicted using mobile device 124 within visual field 122 of user 120. User 112 is depicted having a conversation with user 114 with speech 116, depicted as a speech bubble, corresponding to user 112 and speech 118 corresponding to user 114, depicted as a speech bubble. User 126 is depicted in small room 104, away from user equipment 106. User 126 is depicted holding user equipment 128.

In some aspects, user equipment 106 may comprise control circuitry (e.g., control circuitry 504) that executes a media guidance application for notifying different users about content from live video that the different users missed by tailoring important catch-up segments to each different user. User equipment 106, 128, and 124 may have all the same capabilities of user television equipment 602, user computer equipment 604, and wireless user communications device 606 discussed further in relation to FIG. 6 below. For example, the media guidance application may determine that a first user and a second user are watching a soccer game. For example, the media guidance application may recognize a face of a first user and a face of a second user using a user input interface (e.g., user input interface 510 or any other peripheral device, such as a device connected via input/output (hereinafter “I/O”) path 502 to processing circuitry 506 discussed further below in relation to FIG. 5), such as a camera accessible user equipment 106 via control circuitry 504. For example, the media guidance application may actively detect objects, motion, etc. using a camera (e.g., via user input interface 510) accessible to the media guidance application. For example, the media guidance application may use an edge detection algorithm to detect boundaries between objects in a visual field of a camera. The media guidance application may classify detected objects by, for example, using an object class detection algorithm. For example, the media guidance application may detect edges of an object as described above. The media guidance application may compute distances between vertices of the edges. The media guidance application may compare the distances (or proportions of distances) to a database listing object classes and corresponding edge distances to identify an object class having similar distances. If the media guidance application determines that the object class is a face, the media guidance application may attempt to identify a user corresponding to the face.

The media guidance application may compare an identified face to a database listing faces of users to determine the identify of a user. For example, the media guidance application may access a database comprising faces tagged by users. For example, the media guidance application access a photo gallery database (e.g., a Facebook photo gallery database) where faces of users are tagged. The media guidance application may compare the distances of vertices in the identified face to distances of vertices in faces tagged in the database to identify a user matching the identified face. The media guidance application may track the face of the user during the presentation of the live media to determine whether the user is distracted.

The media guidance application may determine that the first user and the second user, missed important content and may tailor important catch-up segments to each different user. For example, the media guidance application may retrieve data associated with the media, such as data identifying a portion of the media as important (e.g., data supplementing a MPEG data stream may contain a flag identifying whether a frame is important). The media guidance application may select a frame from the media that each user would find most important and may present the frame to each user to catch the user up on the portion. For example, the media guidance application may determine that a first user is a L.A. Lakers fan and that the second user is a Chicago Bulls fan. The media guidance application may present to the first user a frame having a L.A. Lakers player and the media guidance application may present to the second user a frame having a Chicago Bulls player.

In some aspects, the media guidance application may determine, during a first period, that a first user and a second user are disregarding a portion of live video corresponding to the first period. For example, the media guidance application may detect the first and the second user using facial recognition as described above.

As referred to herein, a “portion” of a media asset may refer to any part of a media asset, such as a live video, that is distinguishable from another part of the media asset. For example, a portion may correspond to a frame, set of frames, scene, chapter, segment of time, etc. The media guidance application may identify distinct portions based on time-marks (e.g., a portion begins at a first time mark and ends at a second time mark) in the play length of a media asset. Alternatively or additionally, the media guidance application may identify portions based on a range of frames (a portion begins at a first frame and ends at a second frame). Alternatively or additionally, the media guidance application may identify portions based on content in the media asset (a portion may begin at the appearance of particular content and end at the appearance of the same or different content). Alternatively or additionally, the media guidance application may identify portions based on metadata associated with the media asset (a portion may begin at a first metadata tag and end at a second metadata tag. In some embodiments, the portions of the media asset may correspond to a time when the user is disregarding media. For example, the media guidance application may determine at a first time that a user is disregarding the media, and at a second time that the user is no longer disregarding the media. The media guidance application may correlate the first time and the second time to a time in the media. The media guidance application may select as the portion frames in the media corresponding to time between the first time and the second time.

As referred to herein, a “frame” may be any image associated with media. For example, a frame of a movie may be an image captured at a specific point in the movie. A movie may comprise a sequence of frames for playback in a specified order. The media guidance application may perform image processing on a frame of media to determine if there is important content in the media.

In some embodiments, the media guidance application may track a position of the face of the first user and of the second user to determine whether the first user and the second user are disregarding the portion of the media. For example, the media guidance application may identify the face of user 110 as described above. The media guidance application may determine that user 110 is not disregarding the portion of the media because the face of user 110 is facing user equipment 106. In contrast, the media guidance application may track the face of user 120 as described above. The media guidance application may determine that user 120 is disregarding the media because the media guidance application may detect that the face of user 120 is not longer visible to a camera of user equipment 106. For example, the media guidance application may determine that user 120 is disregarding the media when the 120 turns his back to user equipment 106 because the face of user 120 will no longer be visible by a camera of user equipment 106. For example, the media guidance application may determine that visual field 122 corresponding to user 120 only comprises mobile device 124 (e.g., based on detecting a position of the face of user 120 and approximating what user 120 can see) and therefore determines that the user cannot view the media on user equipment 106.

In some embodiments, the media guidance application may determine that the first user and the second user are disregarding the media based on a gaze point of the first and of the second user. For example, the media guidance application may generate for display the live video on first user equipment, such as a user equipment 106. The media guidance application may detect, using a camera associated with the first user equipment, a first gaze point corresponding to the first user and a second gaze point corresponding to the second user relative to the first user equipment.

In some embodiments, a gaze point of the first user and of the second user may be collected using eye tracking equipment, such as eye wear or other equipment comprising optical or biometric sensors. For example, the media guidance application may detect using a user input device, such as a camera embedded in glasses of a user a direction in which a user's eyes are facing. The media guidance application may correlate the direction with a position of user equipment 106 to determine a gaze point of the user. For example, the media guidance application may determine, based on the information from the camera embedded in the glasses, that user 110 is looking straight. The media guidance application may determine, based on facial recognition of user 110, that user 110 is facing user equipment 106. The media guidance application may compute, based on the position of the user's eyes and the position of the user's face a visual field associated with the user, such as visual field 108. The media guidance application may correlate visual field 108 with a position of user equipment 106 to determine if user equipment 106 is within the visual field of user 110. If user equipment 106 is within visual field 108 of user 110, the media guidance application may determine that the user is not disregarding the media. If user equipment 106 is not within visual field 108 the media guidance application may determine that user 110 is disregarding the media.

In some embodiments, the media guidance application may determine an eye position associated with the first user and an eye position associated with the second user, as described above, and may determine, based on the respective eye positions, whether the first user and the second user are looking at the first user equipment (e.g., user equipment 106). The media guidance application may determine that the first user an the second user are disregarding the live video in response to determining that the first gaze point and the second gaze point do not correspond to the first user equipment (e.g., user equipment 106) based on a visual field of the first user and the second user. If the media guidance application determines that the first and the second user are not looking at the first user equipment (e.g., user equipment 106), the media guidance application may determine that the users are disregarding the live media.

In some embodiments, the media guidance application may determine whether the first user and the second user are disregarding the portion of the media based on sound detected by the media guidance application. For example, the media guidance application may have access to a user input device, such as an integrated microphone capable of detecting sound waves. The media guidance application may monitor sound in large room 102 where user equipment 106 is located. The media guidance application may filter the sound such that ambient noise, such as noise from a fan, or noise generated by the media guidance application itself, such as sound generated from speakers of user equipment 106 accessible to the media guidance application, are filtered out by the media guidance application. The media guidance application may detect that the first user (e.g., user 112) and the second user (e.g., user 114) are disregarding the portion of the media when the media guidance application determines that that sound from voices of the first user (e.g., speech 116) and the second user (e.g., speech 118) are greater than a threshold value. For example, the media guidance application may compare a volume, after the filtering described above, of the noises in room 102. The media guidance application may determine that noises, after the filtering, correspond to talking within the room. For example, the media guidance application may generate a fingerprint identifying unique characteristics of the sound and may compare the unique characteristics of the sound to characteristics typical of human speech. The media guidance may determine that if the characteristics of the sound match the characteristics of human speech that the first user and the second user are disregarding the media (e.g., because the first user and the second user may be talking to each other).

In some embodiments, the media guidance application may uniquely identify the first user and the second user based on the detected sound. For example, the media guidance application may have access to a database comprising a voice template for a plurality of users. The media guidance application may compare detected sounds to the voice template to determine whether the template matches a voice template for a user. If the sound matches a voice template for a user, the media guidance application may determine the identity of the user.

In some embodiments, the media guidance application may determine that the first user and the second user are disregarding the portion of live video when the users are outside of a range of the first user equipment (e.g., user equipment 106). For example, the media guidance application may determine that the first user and the second user are disregarding the portion when a second user equipment device (e.g., user equipment 128) corresponding to the first user (e.g., user 126) and a third user equipment device corresponding to the second user (e.g., a smartphone of the second user) are outside of a wireless communication range of the first user equipment (e.g., user equipment 106). For example, the media guidance application may identify the second user equipment (e.g., user equipment 128) associated with the first user (e.g., user 126) and the third user equipment associated with the second user based on the respective first and second profile data (e.g., the media guidance application may determine that the second device and the third device are linked to the first and second user profile, respectively).

In some embodiments, the media guidance application may retrieve a user profile from memory. For example, the media guidance application may determine whether a user profile exists by first identifying the user (e.g., login information, a picture of the user, a voice of the user, a hash value uniquely identifying the user or any other known identifying information of the user), and then by cross-referencing the user's identity against entries of a user profile database. As a result of the cross-referencing, the media guidance application may receive a pointer to a profile if one is located or may receive a NULL value if the profile does not exist. The user profile database may be located remote or local to the media guidance application (e.g., on storage 508 or on media guidance data source 618 accessed via communications network 614 described in relation to FIG. 5 and FIG. 6 below). If a user profile is located, the media guidance application may access database entries corresponding to user equipment devices associated with the user. For example, the media guidance application may determine that the user has a smartphone and a tablet linked to his or her profile.

In some embodiments, the media guidance application may determine, based on the user profile, that the user has a preferred device. For example, the media guidance application may determine that the user has a preference for using his or her smartphone as opposed to the tablet. In some embodiments, in response to determining the preference, the media guidance application may select the smartphone as the device associated with the user and may search for the smartphone to determine whether the smartphone is within a wireless range.

In some embodiments, the media guidance application may approximate a position of a user based on a location of a device associated with the user. For example, the media guidance application may determine, at a first time, before the first period, that a second user equipment device is within a first distance of the first user equipment device. For example, the media guidance application may communicate wirelessly (e.g., via communications path 612, described below in relation to FIG. 6) to a plurality of user equipment devices. The media guidance application may identify each user equipment device based on a unique identifier associated with each user equipment device. The media guidance application may retrieve a unique identifier for each device that is within a wireless range of user equipment 106 (e.g., by querying each device within a wireless range, or by querying a centralized network device having a listing of all devices within a wireless range, such as a router). The media guidance application may compare each unique identifier to a profile associated with a user to determine whether a unique identifier of the mobile device appears in the profile of the user. If the media guidance application determines that the unique identifier of the mobile device appears in the profile of the user, the media guidance application may determine that the user equipment device belongs to the user.

In some embodiments, the media guidance application may identify a plurality of user equipment within the wireless range that belong to the user. For example, the media guidance application may transmit a network discovery packet over a network connection shared with a plurality of user equipment devices. The media guidance application may aggregate a list of user equipment that respond to the discovery packet. The media guidance application may determine whether a device of the aggregated list of devices is within a number of hops to the media guidance application to approximate whether a device is within a range of the first user equipment device. For example, the media guidance application may determine that when a device is greater than a threshold number of hops away from the media guidance application, the device is not in close proximity to the first user equipment device (e.g., user equipment 106). In an example, the media guidance application may determine that the user has a tablet, a smartphone, a smart watch, and augmented reality glasses within a range of user equipment 106.

In some embodiments, the media guidance application may identify a user equipment most likely to approximate a location of the user. For example, the media guidance application may retrieve user profile data as described above identifying a user equipment device of the plurality of user equipment devices as a user's preferred device. For example, the media guidance application may detect data identifying the smartphone as the user's primary device and may therefore determine that a location of the smartphone corresponds to a location of the user.

In some embodiments, the media guidance application may approximate a location of the user based on a usage parameter of user equipment. For example, the media guidance application may query a set of augmented reality glasses associated with the user to determine whether a display of the augmented reality glasses is turned on (e.g., usage parameter). The media guidance application may determine that a location of the augmented reality glasses likely approximates a location of the user if the screen of the augmented reality glasses is turned on (e.g., because presumably the user is using the augmented reality glasses when the screen is turned on).

In some embodiments, the media guidance application may approximate a distance of the first user and the second user to the first user equipment device. For example, the media guidance application may determine that a user is at a location of a user equipment device, such as a smartphone, using the steps described above. The media guidance application may determine a first relative received signal strength (RSSI) of a wireless signal at the first user equipment device and may determine a second RSSI of the wireless signal at the second user equipment deice. The media guidance application may determine, based on a difference between the first RSSI and the second RSSI an estimated distance between the first user equipment device and the second user equipment device. In another example, the media guidance application may measure received RF power over a shared wireless signal to estimate a location of the user.

In some embodiments, the media guidance application may store data identifying the location of the first user and the second user at a first time. For example, the media guidance application may store, at the first time before the period, a location of the user. For example, the media guidance application may store data associating a RSSI corresponding to the second and third user equipment with a first time, such as a system time when the media guidance application detects that the user equipment is within the range. In some embodiments, the media guidance application may periodically update a location of the second user equipment device. For example, the media guidance application may identify an interval for polling the second and third user equipment (e.g., based on a polling interval stored in memory). The media guidance application may, at the polling interval, measure the RSSI corresponding to the second user equipment device and may store the measured RSSI in the memory.

In some embodiments, the media guidance application may determine, at a second time during the first period, that the second user equipment and the third user equipment are greater the threshold maximum distance between the first user equipment and the second and third user equipment. For example the media guidance application may determine at a second time (e.g., time within the period) that the second user equipment is at a second distance, different from the first distance. For example, the media guidance application may determine a second location of the second user equipment using any of the methods described above and may compare the second location to the first location stored in the memory. The media guidance application may retrieve a threshold maximum distance from memory and may compare the second distance to the threshold distance to determine whether the second distance is greater than the threshold distance. If the media guidance application determines that the second distance is greater than the threshold distance, the media guidance application may determine that the user of the second user equipment device cannot view a display of the first user equipment (e.g., user equipment 106), therefore the user is disregarding the live video. The media guidance application may apply a similar process for determining a location of the third user equipment.

In some embodiments, the media guidance application may configure the threshold maximum distance based on a user input. For example, the media guidance application may prompt the user for a distance from the first user equipment device where the user can no longer see the display. The media guidance application may store the distance in memory as the threshold maximum distance.

In some embodiments, the media guidance application may estimate the threshold maximum distance. For example, the media guidance application may use sonar, lasers, depth cameras, or any other technique to approximate a size of a room (e.g., large room 102) in which the first user equipment device (e.g., user equipment 106) is located. The media guidance application may compute the threshold maximum distance such that the threshold maximum distance is slightly greater than the size of the room (e.g., so that the maximum distance is outside of an area where the user can see the first user equipment). In another example, the media guidance application may retrieve from a database an average size of a room and may compute the threshold maximum distance to be greater than or equal to the average size of the room (e.g., large room 102 and/or small room 104).

In some embodiments, the media guidance application may determine that the first user and the second user are disregarding the live video in response to determining that the second user equipment and the third user equipment are greater than the threshold maximum distance away from the first user equipment. For example, the media guidance application may determine that if the first user and the second user are greater than the threshold maximum distance away from the first user equipment, that the users cannot view the display and are therefore disregarding the live video. The media guidance application may approximate a second distance of the first and second user as described above and may retrieve a threshold maximum distance from a remote data source. The media guidance application may compare the second distance to the threshold maximum distance and may detect that the users are outside the range and therefore are disregarding the live video.

The above embodiments above and below are discussed in relation to a first user and a second user; however, the media guidance application may monitor any number of users. For example, the media guidance application may monitor each user depicted in large room 102 and small room 104 using a plurality of methods. For example, the media guidance application may monitor a first user and a second user by detecting voices from the first and second user. The media guidance application may monitor a third user based on a location of an electronic device belonging to the third user. The media guidance application may monitor a forth user by tracking an eye position of the forth user. The media guidance application may make a determination that any subset of users (e.g., all users, no users, two users, etc.) is disregarding the video using any of the methods described above.

In some aspects, the media guidance application may identify a micro-portion of the portion of live video that corresponds to an important event in the live video. For example, the media guidance application may retrieve data (e.g., data associated with a video stream for the live video) identifying important frames in the media. For example, the media guidance application may detect that frames of the live video are numbered. The media guidance application may determine, based on the data, that an important portion begins at frame number N and ends at frame number N+2000 in the live video. The media guidance application may select frames N to N+2000 as a micro-portion corresponding to an important event in the live video.

As referred to herein, “important event” refers to anything in media that may be noteworthy or significant. For example, important event in a hockey game may be a power play, since there is a greater likelihood of scoring during a power play than not. In another example, an important event may be a significant plot development in a television show, such as a death of a main character. In another example, an important event may be a scene of a movie having high social chatter. In another example, an important event in a movie may be an actor saying a famous quote.

Important events may be crowd sourced. For example, the media guidance application may retrieve data from social media networks to identify important events in media. For example, the media guidance application may retrieve hash tags related to media or data from a social network, such as Facebook, identifying content that is most shared or discussed on (e.g., Facebook's “most talked about” data). The media guidance application may identify a portion of a media asset corresponding to high social chatter by, for example, determining that many users have shared a clip from a media asset (e.g., based on Facebook's “most talked about” data. The media guidance application may create a fingerprint for the clip and may compare the fingerprint of the clip to a database of fingerprints for media to identify a portion of the media matching the fingerprint.

Important events may be manually tagged by a content provider or a third party. For example, a sports broadcasting network may tag important plays in a sporting event in real time or may tag important plays for a retransmission of an event. The media guidance application may retrieve metadata, with or separate from a video stream associated with the sporting event comprising the tags.

As referred to herein, “micro-portion” corresponds to any subset of a “portion” as described above. In some embodiments, the portion may correspond to frames of a media asset. The micro-portion may correspond to a subset of the frames of the portion. In some embodiments, the media guidance may identify a portion having events that are deemed objectively important. For example, the media guidance application may determine that a portion of a movie corresponds to an important scene in the movie. In some embodiments, the media guidance application may identify frames from the portion of interest to a specific user as the micro-portion. For example, the media guidance application may identify a micro-portion of the important scene (e.g., the portion) as frames of the portion where an actor of interest to the user appears. In other words, while a portion may refer to an objectively important event, a micro-portion generally refers to a point in the portion that is subjectively especially important to a given particular user.

In some embodiments, the media guidance application may run an image processing algorithm, such as an object detection algorithm on the frame, to determine if the frame comprises important content. For example, the media guidance application may perform edge detection within a particular frame and, based on the results, detect contours of various objects within the frame. For example, the media guidance application may perform a search-based or a zero-crossing based edge detection method on a frame of the media. The media guidance application may approximate a first derivative of pixel data corresponding to the frame to derive a gradient for the image (e.g., by convolving the image with a kernel, such as a Sobel operator). Based on the gradient, the media guidance application may identify local minima or maxima in the gradient. The media guidance application may suppress all pixels not identified as a local minima or maxima and may apply thresholding or hysteresis to filter the output.

When the media guidance application completes the edge detection process, the media guidance application may extract an object discovered during edge detection. For example, the media guidance application may create a fingerprint for objects in the frame based on the edge detection algorithm as described above. The media guidance application may compare the fingerprint for the frame to an object database that stores object fingerprints that are known and have been categorized into known objects. The object database may also store descriptions of the objects contained within the object database. When the media guidance application detects a particular object in a frame, the media guidance may retrieve keywords describing the object from the object database. The media guidance application may use the keywords to generate a description of an event occurring in the live video.

In some embodiments, the media guidance application may perform an image processing algorithm to detect characters in a live video. For example, the media guidance application may perform an optical character recognition (“OCR”) algorithm to detect characters in the live video and may generate a set of string coordinate pairs corresponding to the text in the live video. For example, the media guidance application may retrieve a frame of the live video, such as a financial news broadcast. The media guidance application may detect text in a news ticker at a bottom of the frame of the media asset (e.g., by performing the object detection procedures as described above and detecting characters). The media guidance application may generate a string matching the string in the news ticker by performing the OCR algorithm on the frame. The media guidance application may associate the string with a position of the original string in the frame (e.g., the bottom of the frame).

In some embodiments, the media guidance application may retrieve data from a plurality of sensors associated with the media. For example, the media guidance application may determine that the media is a live sporting event based on metadata of a MPEG-4 stream received by the media guidance application. The media guidance application may query a remote database for sensor information of players or other objects in the sporting event. For example, the media guidance application may transmit a unique identifier for the sporting event to the remote database. The media guidance application may retrieve data from a plurality of sensors associated with the sporting event. For example, the live sporting event may be a football game. The media guidance application may retrieve data from a sensor embedded in the football listing a position in the field and a speed of travel(e.g., based on a GPS or other triangulation sensor), an indication that the ball is on the ground or is being held (e.g., based on a pressure sensor or impedance sensor embedded on the ball), etc. In another example, the media guidance application may retrieve information from sensors embedded on players, such as a force of impact (e.g., based on an accelerometer) , sound data from a microphone on the player, an position on the field based on a triangulation sensor, etc.

In some embodiments, the media guidance application may determine based on the sensor data whether the portion is important. For example, the media guidance application may correlate information from the sensors with a look-up table of sensor values indicating important events. For example, the media guidance application may receive an indication that a soccer ball is in close proximity to a soccer goal (e.g., based on the retrieved sensor data). The media guidance application may correlate the position of the soccer ball with a table listing threshold distances between the soccer goal and the soccer ball to identify important content. If the soccer ball is less than a threshold distance to the soccer goal, the media guidance application may determine that the portion where the soccer ball is within the threshold distance is important.

In some embodiments, the media guidance application may identify the micro-portion corresponding to the important event in the live media by determining a respective type of each micro-portion of the portion. For example, the media guidance application may generate a string of keywords corresponding to the frames as described above. The media guidance application may determine that a micro-portion of the live media corresponds to a touchdown in a football game and may determine that a second micro-portion corresponds to a five yard running play in the football game. The media guidance application may retrieve, from a database, a set of popular types of micro-portions and may compare the keywords generated based on the frames to the popular types. For example, the media guidance may determine, based on the set of popular types, that a touchdown is a popular type but a five yard running play is not a popular type (e.g., because a touchdown may affect a team's chance of winning greater than a five yard running play). For example, the media guidance application may determine that a micro-portion of the live video corresponds to a touchdown scored by the Giants and may generate the keywords “touchdown,” “Giants,” “football,” etc. The media guidance application may compare the key words to descriptions of types from the set and may determine that the micro-portion corresponds to an important event in the live video if the type of the micro-portion matches a type from the set (e.g., if the micro-portion corresponds to a touchdown the media guidance application may determine that the micro-portion is important, but if the micro-portion corresponds to a five yard running play the media guidance application may determine that the micro-portion is not important).

In some embodiments, the media guidance application may determine whether the micro-portion corresponds to the important event in the live media based on performing image processing on the frames of the portion of the live media and determining whether the frames correspond to an image processing rule. The media guidance application may retrieve a frame of the live video generated for display during the portion. For example, the media guidance application may retrieve a frame of the live video corresponding to a portion of the live video that is missed by the first and second user. The media guidance application may analyze the frame using an image processing algorithm to determine whether the frame matches an image processing rule. For example, the media guidance application may analyze the first frame to determine whether there is fast action during the frame. The media guidance application may detect an object in a frame of the set of frames, as described above and may track motion of the object using an accelerated motion vector processing by detecting a position of the object in each frame of the set of frames. If the motion of the object is determined by the media guidance application to be greater than a threshold value, the media guidance application may associate the portion with a fast motion characteristic.

In another example the media guidance application may retrieve an image processing rule defining a micro-portion of a football game as important when it is detected that an object, such as a football, is less than 20 yard from an end zone, because there is a higher probability of scoring when the football is close to an end zone. The media guidance application may determine that the frame corresponds to the important event when the frame matches the image processing rule.

In some aspects, the media guidance application may retrieve a first profile of a first user and a second profile of a second user from memory as described above. For example, the media guidance application may query a remote database (e.g., using network connection of the media guidance application) for profile data associated with a first user and profile data associated with the second user. The media guidance application may request respective user profile data corresponding to characteristics that the respective users deem important in media (e.g., favorite sports teams, favorite actors/actresses, media viewing history, fantasy sports rosters etc.).

In some aspects, the media guidance application may determine, based on data of the first profile, a first criterion characterizing content that is important to the first user. For example, the media guidance application may determine, based on the user profile, that a user participates in a fantasy sports contest. The media guidance application may retrieve, from the user profile, data identifying a user's fantasy sports roster. The media guidance application may determine a criterion based on the fantasy sports roster. For example, the criterion may define a characteristic of a frame (e.g., a jersey number of a player in the frame, facial recognition of a player in the frame) matching a player in the roster as having significance to the user. In another example, the media guidance application may determine that the criterion corresponds to a player in a sports event, when the media guidance application determines that the user has set up an alert for updates on the player in the user's profile. In another example, the media guidance application may retrieve data from the first user profile identifying the first user's favorite sports teams. The media guidance application may determine, based on the data, that the first user watches soccer and is a fan of the soccer team Celta Vigo, and may resultantly determine that the first criterion is whether the media includes a Celta Vigo player.

As referred to herein, “criterion characterizing content that is important” is any feature of a video characterizing content of the video that may be important to a user. The criterion characterizing content that is important may be based on user profile data. For example, a criterion may be whether media has a sports player that is also in a user's fantasy sports roster. For example, a user may have a sports player in his or her fantasy sports roster. An criterion characterizing content that is important may be that the fantasy sports player is actively playing in a real- life sporting event; because, for example, the performance of the player may affect the user's fantasy sports score. In another example, criterion characterizing content that is important may be based on a social media profile of the user. For example, the media guidance application may determine that the user “likes” a celebrity, such as Ben Stiller, on a social media profile, such as a Facebook profile. The media guidance application may identify Ben Stiller in a portion of a television program as an important event. In another example, a criterion characterizing important content may be based on the user profile data accessible to the media guidance application, such as age, gender, demographic data, etc. For example, the media guidance application may determine that a user lives in the New England. The media guidance application may determine that because the user lives in New England that the user is interested in weather forecasts for New England.

In some aspects, the media guidance application may determine, based on data of the second profile, a second criterion characterizing content that is important to the second user and is different from the first criterion. For example, the media guidance application may analyze the second user profile and may determine that the second user frequently watches soccer games of the soccer team FC Barcelona. The media guidance application may determine that the second criterion is whether the media includes a FC Barcelona player based on the determination that the user frequently watches FC Barcelona games. The media guidance application may determine a second criterion different from the first criterion when the second profile data is different from the first profile data (e.g., when the media guidance application determines that the first user and the second user have different preferences).

In some aspects, the media guidance application may retrieve data corresponding to the micro-portion. For example, the media guidance application may generate key words describing an event in the micro-portion using image processing as described above. In some embodiments, the media guidance application may query a database for data associated with the live video. For example, the media guidance application may retrieve from the database, a description of events occurring in the micro-portion. For example, the media guidance application may retrieve data identifying a goal scored in the micro-portion along with statistics for players who were involved in the scoring play.

Following from the previous example, the media guidance application may determine, based on the retrieved data that the micro-portion corresponds to a goal scored by Celta Vigo in a soccer game verses FC Barcelona.

FIG. 2 shows an illustrative embodiment of catch-up portions tailored to a first user and a second user generated for display with live media, in accordance with some embodiments of the disclosure. User equipment 200 is depicted first catch-up window 202, second catch-up window 212 and live video 222. First catch-up window 202 is depicted having first welcome message 204. The media guidance application may optionally generate for display welcome message 204 to indicate to the first user that the catch-up portion is tailored to he or she. First catch-up window is further depicted having first event description 206, first frame 208 and first frame description 210. The media guidance application may optionally generate for display first event description 206, first frame 208 and first frame description 210 to inform the first user about important content in the media missed by the first user. Second catch-up window is depicted having second welcome message 214. The media guidance application may optionally generate for display second welcome message 214 to indicate to the second user that the catch-up content is intended for he or she. Second catch-up window is further depicted having second event description 216, second frame 218 and second frame description 220. The media guidance application may optionally generate for display first event description 216, first frame 218 and first frame description 220 to inform the second user about important content in the media missed by the second user. The media guidance application may optional generate for display live video 222, first catch-up window 202, second catch-up window 212 and all other elements of catch-up window 202 and second catch-up window 212 on user equipment 106, 128 and/or 124.

In some aspects, the media guidance application may identify, based on the retrieved data corresponding to the micro-portion, a first frame of the micro-portion matching the first criterion and a second frame of the micro-portion matching the second criterion, wherein the second frame is different from the first frame. Following from the previous example, the media guidance application may identify a first frame corresponding to a Celta Vigo player that scored the goal and may identify a second frame corresponding to a FC Barcelona player that missed a tackle during the scoring play. For example, the media guidance application use an image processing algorithm as described above, to identify objects in the frames of the micro-portion. The media guidance application may, based on the detected objects in the frames, compare the frames to the first criterion and the second criterion. For example, if the first criterion is any Celta Vigo player, the media guidance application may select a plurality of frames corresponding to Celta Vigo players (e.g., frames where the media guidance application detects a Celta Vigo player based on object recognition, jersey color, player names or numbers, metadata provided with the video stream, etc.) Likewise, the media guidance application may perform a similar process to identify a second frame matching the second criterion. In an example, the media guidance application may identify a second frame comprising a FC Barcelona player when the second criterion is for all players on FC Barcelona.

In some embodiments, the media guidance application may retrieve from a database a listing of objects, such as jersey numbers, uniform colors, and player numbers associated with the first criterion (e.g., the Celta Vigo) and identify a second plurality of objects, such as uniform colors and player faces associated with the second criterion (e.g., the FC Barcelona).The media guidance application may perform object recognition on each respective frame of the plurality of frames associated with the micro-portion to identify a respective plurality of objects associated with each respective frame as described above. For example, the media guidance application may recognize objects in each frame, such as players recognized based on jersey numbers and colors. The media guidance application may select a first frame in response to determining that the first frame is associated with the first plurality of objects and may select a second frame in response to determining that the second frame is associated with a second plurality of objects (e.g., objects associated with the second criterion).

In some embodiments, the media guidance application may identify, from a first plurality of frames associated with the micro-portion, a second plurality of frames each comprising an object matching the first plurality of objects. For example, the media guidance application may identify all frames of the micro-portion having an object matching the criterion. For example, the media guidance application may select a second plurality of frames from a first plurality of frames associated with the micro-portion each having objects associated with Celta Vigo, such as Celta Vigo players, based on the object recognition as described above. The media guidance application may rank each respective frame of the second plurality of frames based on a respective amount of objects in the respective frame matching the first plurality of objects. For example, the media guidance application may rank each frame based on a number of Celta Vigo players located in each frame of the second plurality of frames.

In some embodiments, the media guidance application may select a frame as the first frame in response to determining that the first frame has a highest respective amount of objects matching the first plurality of objects with respect to each frame of the second plurality of frames. For example, the media guidance application may select a frame from the second plurality of frames having a greatest number of Celta Vigo players. The media guidance application may select the first frame as representative of important content, for example, because the goal was scored by Celta Vigo.

In some embodiments, the ranking may be based on further characteristics of the identified players in the frame. For example, the media guidance application may determine a weighting for each object detected on the screen. For example, the media guidance application may determine, based on the metadata associated with the live video (e.g., live video 222), that player number five on Celta Vigo (e.g., Celta Vigo forward Nolito) scored the goal and player number four on the FC Barcelona (e.g., FC Barcelona defender Pique) nearly missed a tackle which caused the goal.

The media guidance application may rank an importance of each object in the frame (e.g., using a 0-5 scale). The media guidance application may give player five (e.g., Nolito) of Celta Vigo and player four (e.g., Pique) of FC Barcelona a highest ranking (e.g., 5) because those players were directly related to the important event (e.g., as identified by the media guidance application). Contrarily, objects with little impact on the important event, such as a detected fan in the stands of a stadium may be given a zero. The media guidance application may compute a score for each frame and based on the score of each frame may rank the second plurality of frames.

In some embodiments, the media guidance application may select the frame having the highest ranking based on the score. For example, the media guidance application may determine that a frame having the highest score is a frame showing a clear shot of Nolito (e.g., because Nolito scored the goal), such as first frame 208. The media guidance application may generate for display the first frame (e.g., first frame 208) in a catch-up window (e.g., first catch-up window 202).

In some aspects, the media guidance application may generate for display to the first user information associated with the first frame (e.g., frame 208). For example, the media guidance application may generate key words associated with the frames as described above. The media guidance application may generate for display a word representative of the frame (e.g., in first catch-up window 202 at first frame description 210 or first event description 206). For example, the media guidance application may determine that the frame is directed to a goal scoring play and may generate for display the text “GOAL!!”.

In some aspects, the media guidance application may generate for display to the second user information associated with the second frame (e.g., second frame 218). For example, the media guidance application may identify a second frame (e.g., second frame 218) using the same process in relation to selecting the first frame. The media guidance application may identify a mobile device associated with the second user, such as user equipment 128, and may generate for display information (e.g., second frame description 220) associated with the second frame (e.g., second frame 218) to the second user (e.g., user 126) on user equipment 128.

In some embodiments, the media guidance application may generate for display text corresponding the first frame. For example, the media guidance application may generate for display text corresponding to the largest or a highest ranking object within a frame. In an example, the media guidance application may compute a respective amount of pixels corresponding to each object of the first plurality of objects within the first frame. For example, the media guidance application may determine an amount of pixels corresponding to each Celta Vigo player in the first frame. For example, the media guidance application may determine a boundary for each object of a plurality of objects detected in the frame. Based on the boundary, the media guidance application may determine a respective amount of pixels within the boundary (e.g., a number of pixels corresponding to the object). The media guidance application may retrieve information about the object corresponding to a highest number of pixels. For example, the media guidance application may query a database for information associated with the object and may generate for display the information. For example, the media guidance application may determine that the player corresponding to the highest number of pixels is the forward, such as Celta Vigo forward Nolito. The media guidance application may retrieve information describing Nolito's performance during the play. The media guidance application may perform a similar process for generating text corresponding to a highest ranked object in the frame.

In another embodiment, the media guidance application may generate for display information associated with a player in the first user's fantasy sports roster in response to determining that the player is in the frame. For example, the media guidance application may determine that a player is in the first user's fantasy sports roster based on retrieved user profile data as described above. The media guidance application may perform object recognition on the frame to determine that an object in the frame is the player. The media guidance application may compute a change in the user's fantasy sports score based on an event in the frame and may generate for display a textual description describing the change in the user's fantasy sports score. For example, if a player that scored a goal in the important event corresponds to the user's fantasy sports roster (e.g., is on the user's fantasy sports roster), the media guidance application may generate for display statistics associated with the player and may generate for display information describing how a user's fantasy sports score changed based on the goal (e.g., important event).

In some embodiments, the media guidance application may retrieve, from a database, a textual template associated with the largest or the highest ranked object. For example, the media guidance application may determine that the largest or highest ranked object is Celta Vigo forward Nolito. The media guidance application may retrieve a textual template associated with Nolito, such as a textual template describing statistics a user may find important about a soccer player who scored a goal. Based on the template, the media guidance application may retrieve supplemental data to fill the template, such as an amount of time the player had possession, whether the player avoided any slide tackles, etc. The media guidance application may generate for display the text describing the object based on the retrieved textual template and supplemental data. For example, the media guidance application may generate for display text describing first frame 208, such as first frame description 210, and may generate for display text describing second frame 218, such as second frame description 220.

In some embodiments, the media guidance application may generate for display on the second user equipment (e.g., user equipment 128) the information associated with the first frame in response to determining, at a third time later than the second time, that the second user equipment is within the threshold maximum distance away from the first user equipment. For example, as described above, the media guidance application may track the location of the second user equipment by, for example, polling a location of the second user equipment. The media guidance application may, in response to determining that the second user equipment is back within a range of the first user equipment device (e.g., user equipment 106), generate for display the first frame (e.g., first frame 208). Likewise, the media guidance application may generate for display to the second user the second frame (e.g., second frame 218) when the second user is detected to be within the threshold maximum distance away from the first user equipment (e.g., so that the first user and the second user can catch-up to the live media, such as live video 222). In some embodiments, the media guidance application may generate for display to the first user and to the second user a description of the first frame and of the second frame respectively (e.g., first frame description 210 and second frame description 220).

In some embodiments, the media guidance application may generate for display on the second user equipment, at the second time, the information associated with the first frame in response to determining that the second user equipment device is greater than the threshold maximum distance away from the first user equipment. For example, as described above, the media guidance application may track a location of the second user equipment (e.g., user equipment 128). The media guidance application may push a notification (e.g., via a network connection between the second user equipment and the first user equipment) to the second user equipment comprising the information associated with the first frame. For example, when the media guidance application determines that the first user is away from the first user equipment (e.g., user equipment 106) the media guidance application may provide catch-up content to the user so that he or she may catch-up to the live content before returning to the first user equipment.

In some embodiments, the media guidance application may generate for display supplemental content associated with the frame. For example, the media guidance application may generate for display a hyperlink to an article or webpage describing content in the frame. In another example, the media guidance application may integrate with a social media platform and may generate for display information from the social media platform. For example, the frame may correspond to a shocking portion of a movie. The media guidance application may generate for display reactions posted by users on social media. In another example, the media guidance application may generate for display a link to a video associated with the frame. For example, the media guidance application may store the portion of the live media (e.g., live video 222) while the user is disregarding the live video. The media guidance application may generate for display to the user an option to view video corresponding to the portion.

In some embodiments, the media guidance application may generate for display an option for the user to view frames from the portion that are of interest to the user. For example, the media guidance application may determine that the user is a Celta Vigo fan. The media guidance application may select frames from the portion corresponding to players on Celta Vigo using any of the methods described above. The media guidance application may generate for display the frames corresponding to the Celta Vigo players to catch-up the user to the live content.

In some embodiments, the media guidance application may present to the user an option to view the portion that was disregarded by the user. For example, the media guidance application may generate for display frames that were disregarded by the user. In some embodiments, the media guidance application may identify a micro-portion of the portion as having important content. The media guidance application may generate for display frames from the portion at a first rate than a second rate for frames from the micro-portion. For example, the media guidance application may generate for display the frames from the portion that are not in the micro-portion at a the first rate (e.g., by skipping frames, 4x fast forwarding) because those frames may not be of interest to the user. In contrast, the media guidance application may generate for display the micro-portion at the second rate, slower than the first rate (e.g., normal playback, 2× fast forwarding) because frames micro-portion may be of interest to the user and the user may therefore want to view them at a slower rate.

In some embodiments, the media guidance application may identify a first plurality of frames of interest to a first user and a second plurality of frame of interest to the second user from the plurality of frames associated with the micro portion. For example, the media guidance application may identify frames from the micro-portion of interest to the first user and frames of interest to the second user using any of the methods described above. The media guidance application may generate for display to the first user video of the micro-portion wherein frames of interest to the first user are played back at a first playback rate slower than a second playback rate of frames from the portion that are not of interest to the first user. The media guidance application may generate for display to the second user video of the micro-portion wherein frames of interest to the second user are played back at a third playback rate slower than a forth playback rate of frames from the portion that are not of interest to the second user.

In some embodiments, the media guidance application may enable a user to control various catch-settings and parameters. For example, the media guidance application may prompt the user for a speed at which the user wants to view the catch-up content. The media guidance application may store, in the user profile, data indicating the speed which the user prefers to view the catch-up content. The media guidance application may retrieve the speed from the user profile and may present the catch-up content at the speed.

In some embodiments, the media guidance application may store an amount of time associated with the catch-up content as set by the user. For example, the media guidance application may determine that the user prefers to view only 30 seconds of catch-up content (e.g., based on an average amount of time a user typically spends catching up on content stored it the user profile). The media guidance application may adjust a playback rate or select certain frames from the micro-portion to create catch-up content that matches the time. For example, the media guidance application may trim frames from the micro-portion until playback of all frames is within 30 seconds.

FIGS. 3-4 show illustrative display screens that may be used to provide media guidance data. The display screens shown in FIGS. 3-4 may be implemented on any suitable user equipment device or platform. While the displays of FIGS. 3-4 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 3 shows illustrative grid of a program listings display 300 arranged by time and channel that also enables access to different types of content in a single display. Display 300 may include grid 302 with: (1) a column of channel/content type identifiers 304, where each channel/content type identifier (which is a cell in the column) identifies a different channel or content type available; and (2) a row of time identifiers 306, where each time identifier (which is a cell in the row) identifies a time block of programming. Grid 302 also includes cells of program listings, such as program listing 308, where each listing provides the title of the program provided on the listing's associated channel and time. With a user input device, a user can select program listings by moving highlight region 310. Information relating to the program listing selected by highlight region 310 may be provided in program information region 312. Region 312 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L. P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 302 may provide media guidance data for non-linear programming including on-demand listing 314, recorded content listing 316, and Internet content listing 318. A display combining media guidance data for content from different types of content sources is sometimes referred to as a “mixed-media” display. Various permutations of the types of media guidance data that may be displayed that are different than display 300 may be based on user selection or guidance application definition (e.g., a display of only recorded and broadcast listings, only on-demand and broadcast listings, etc.). As illustrated, listings 314, 316, and 318 are shown as spanning the entire time block displayed in grid 302 to indicate that selection of these listings may provide access to a display dedicated to on-demand listings, recorded listings, or Internet listings, respectively. In some embodiments, listings for these content types may be included directly in grid 302. Additional media guidance data may be displayed in response to the user selecting one of the navigational icons 320. (Pressing an arrow key on a user input device may affect the display in a similar manner as selecting navigational icons 320.)

Display 300 may also include video region 322, and options region 326. Video region 322 may allow the user to view and/or preview programs that are currently available, will be available, or were available to the user. The content of video region 322 may correspond to, or be independent from, one of the listings displayed in grid 302. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Options region 326 may allow the user to access different types of content, media guidance application displays, and/or media guidance application features. Options region 326 may be part of display 300 (and other display screens described herein), or may be invoked by a user by selecting an on-screen option or pressing a dedicated or assignable button on a user input device. The selectable options within options region 326 may concern features related to program listings in grid 302 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 6.

Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 4. Video mosaic display 400 includes selectable options 402 for content information organized based on content type, genre, and/or other organization criteria. In display 400, television listings option 404 is selected, thus providing listings 406, 408, 410, and 412 as broadcast program listings. In display 400 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 408 may include more than one portion, including media portion 414 and text portion 416. Media portion 414 and/or text portion 416 may be selectable to view content in full-screen or to view information related to the content displayed in media portion 414 (e.g., to view listings for the channel that the video is displayed on).

The listings in display 400 are of different sizes (i.e., listing 406 is larger than listings 408, 410, and 412), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

Users may access content and the media guidance application (and its display screens described above and below) from one or more of their user equipment devices. FIG. 5 shows a generalized embodiment of illustrative user equipment device 500. More specific implementations of user equipment devices are discussed below in connection with FIG. 6. User equipment device 500 may receive content and data via input/output path 502. I/O path 502 may provide content (e.g., broadcast programming, on-demand programming, Internet content, content available over a local area network (LAN) or wide area network (WAN), and/or other content) and data to control circuitry 504, which includes processing circuitry 506 and storage 508. Control circuitry 504 may be used to send and receive commands, requests, and other suitable data using I/O path 502. I/O path 502 may connect control circuitry 504 (and specifically processing circuitry 506) to one or more communications paths (described below). I/O functions may be provided by one or more of these communications paths, but are shown as a single path in FIG. 5 to avoid overcomplicating the drawing.

Control circuitry 504 may be based on any suitable processing circuitry such as processing circuitry 506. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor).

In client-server based embodiments, control circuitry 504 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 6). In addition, communications circuitry may include circuitry that enables peer-to-peer communication of user equipment devices, or communication of user equipment devices in locations remote from each other (described in more detail below).

Memory may be an electronic storage device provided as storage 508 that is part of control circuitry 504. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 508 may be used to store various types of content described herein as well as media guidance data described above. Nonvolatile memory may also be used (e.g., to launch a boot-up routine and other instructions). Cloud-based storage, described in relation to FIG. 6, may be used to supplement storage 508 or instead of storage 508.

Control circuitry 504 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 504 may also include scaler circuitry for upconverting and downconverting content into the preferred output format of the user equipment 500. Circuitry 504 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 508 is provided as a separate device from user equipment 500, the tuning and encoding circuitry (including multiple tuners) may be associated with storage 508.

A user may send instructions to control circuitry 504 using user input interface 510. User input interface 510 may be any suitable user interface, such as a remote control, mouse, trackball, keypad, keyboard, touch screen, touchpad, stylus input, joystick, voice recognition interface, or other user input interfaces. Display 512 may be provided as a stand-alone device or integrated with other elements of user equipment device 500. For example, display 512 may be a touchscreen or touch-sensitive display. In such circumstances, user input interface 510 may be integrated with or combined with display 512. Display 512 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 512 may be HDTV-capable. In some embodiments, display 512 may be a 3D display, and the interactive media guidance application and any suitable content may be displayed in 3D. A video card or graphics card may generate the output to the display 512. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 504. The video card may be integrated with the control circuitry 504. Speakers 514 may be provided as integrated with other elements of user equipment device 500 or may be stand-alone units. The audio component of videos and other content displayed on display 512 may be played through speakers 514. In some embodiments, the audio may be distributed to a receiver (not shown), which processes and outputs the audio via speakers 514.

The guidance application may be implemented using any suitable architecture. For example, it may be a stand-alone application wholly-implemented on user equipment device 500. In such an approach, instructions of the application are stored locally (e.g., in storage 508), and data for use by the application is downloaded on a periodic basis (e.g., from an out-of-band feed, from an Internet resource, or using another suitable approach). Control circuitry 504 may retrieve instructions of the application from storage 508 and process the instructions to generate any of the displays discussed herein. Based on the processed instructions, control circuitry 504 may determine what action to perform when input is received from input interface 510. For example, movement of a cursor on a display up/down may be indicated by the processed instructions when input interface 510 indicates that an up/down button was selected.

In some embodiments, the media guidance application is a client-server based application. Data for use by a thick or thin client implemented on user equipment device 500 is retrieved on-demand by issuing requests to a server remote to the user equipment device 500. In one example of a client-server based guidance application, control circuitry 504 runs a web browser that interprets web pages provided by a remote server. For example, the remote server may store the instructions for the application in a storage device. The remote server may process the stored instructions using circuitry (e.g., control circuitry 504) and generate the displays discussed above and below. The client device may receive the displays generated by the remote server and may display the content of the displays locally on equipment device 500. This way, the processing of the instructions is performed remotely by the server while the resulting displays are provided locally on equipment device 500. Equipment device 500 may receive inputs from the user via input interface 510 and transmit those inputs to the remote server for processing and generating the corresponding displays. For example, equipment device 500 may transmit a communication to the remote server indicating that an up/down button was selected via input interface 510. The remote server may process instructions in accordance with that input and generate a display of the application corresponding to the input (e.g., a display that moves a cursor up/down). The generated display is then transmitted to equipment device 500 for presentation to the user.

In some embodiments, the media guidance application is downloaded and interpreted or otherwise run by an interpreter or virtual machine (run by control circuitry 504). In some embodiments, the guidance application may be encoded in the ETV Binary Interchange Format (EBIF), received by control circuitry 504 as part of a suitable feed, and interpreted by a user agent running on control circuitry 504. For example, the guidance application may be an EBIF application. In some embodiments, the guidance application may be defined by a series of JAVA-based files that are received and run by a local virtual machine or other suitable middleware executed by control circuitry 504. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 500 of FIG. 5 can be implemented in system 600 of FIG. 6 as user television equipment 602, user computer equipment 604, wireless user communications device 606, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 5 may not be classified solely as user television equipment 602, user computer equipment 604, or a wireless user communications device 606. For example, user television equipment 602 may, like some user computer equipment 604, be Internet-enabled allowing for access to Internet content, while user computer equipment 604 may, like some television equipment 602, include a tuner allowing for access to television programming. The media guidance application may have the same layout on various different types of user equipment or may be tailored to the display capabilities of the user equipment. For example, on user computer equipment 604, the guidance application may be provided as a web site accessed by a web browser. In another example, the guidance application may be scaled down for wireless user communications devices 606.

In system 600, there is typically more than one of each type of user equipment device but only one of each is shown in FIG. 6 to avoid overcomplicating the drawing. In addition, each user may utilize more than one type of user equipment device and also more than one of each type of user equipment device.

In some embodiments, a user equipment device (e.g., user television equipment 602, user computer equipment 604, wireless user communications device 606) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 614. Namely, user television equipment 602, user computer equipment 604, and wireless user communications device 606 are coupled to communications network 614 via communications paths 608, 610, and 612, respectively. Communications network 614 may be one or more networks including the Internet, a mobile phone network, mobile voice or data network (e.g., a 4G or LTE network), cable network, public switched telephone network, or other types of communications network or combinations of communications networks. Paths 608, 610, and 612 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 612 is drawn with dotted lines to indicate that in the exemplary embodiment shown in FIG. 6 it is a wireless path and paths 608 and 610 are drawn as solid lines to indicate they are wired paths (although these paths may be wireless paths, if desired). Communications with the user equipment devices may be provided by one or more of these communications paths, but are shown as a single path in FIG. 6 to avoid overcomplicating the drawing.

Although communications paths are not drawn between user equipment devices, these devices may communicate directly with each other via communication paths, such as those described above in connection with paths 608, 610, and 612, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 614.

System 600 includes content source 616 and media guidance data source 618 coupled to communications network 614 via communication paths 620 and 622, respectively. Paths 620 and 622 may include any of the communication paths described above in connection with paths 608, 610, and 612. Communications with the content source 616 and media guidance data source 618 may be exchanged over one or more communications paths, but are shown as a single path in FIG. 6 to avoid overcomplicating the drawing. In addition, there may be more than one of each of content source 616 and media guidance data source 618, but only one of each is shown in FIG. 6 to avoid overcomplicating the drawing. (The different types of each of these sources are discussed below.) If desired, content source 616 and media guidance data source 618 may be integrated as one source device. Although communications between sources 616 and 618 with user equipment devices 602, 604, and 606 are shown as through communications network 614, in some embodiments, sources 616 and 618 may communicate directly with user equipment devices 602, 604, and 606 via communication paths (not shown) such as those described above in connection with paths 608, 610, and 612.

Content source 616 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 616 may be the originator of content (e.g., a television broadcaster, a Webcast provider, etc.) or may not be the originator of content (e.g., an on-demand content provider, an

Internet provider of content of broadcast programs for downloading, etc.). Content source 616 may include cable sources, satellite providers, on-demand providers, Internet providers, over-the-top content providers, or other providers of content. Content source 616 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 618 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 618 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 618 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 618 may provide user equipment devices 602, 604, and 606 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 508, and executed by control circuitry 504 of a user equipment device 500. In some embodiments, media guidance applications may be client-server applications where only a client application resides on the user equipment device, and server application resides on a remote server. For example, media guidance applications may be implemented partially as a client application on control circuitry 504 of user equipment device 500 and partially on a remote server as a server application (e.g., media guidance data source 618) running on control circuitry of the remote server. When executed by control circuitry of the remote server (such as media guidance data source 618), the media guidance application may instruct the control circuitry to generate the guidance application displays and transmit the generated displays to the user equipment devices. The server application may instruct the control circuitry of the media guidance data source 618 to transmit data for storage on the user equipment. The client application may instruct control circuitry of the receiving user equipment to generate the guidance application displays.

Content and/or media guidance data delivered to user equipment devices 602, 604, and 606 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 600 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 6.

In one approach, user equipment devices may communicate with each other within a home network. User equipment devices can communicate with each other directly via short-range point-to-point communication schemes described above, via indirect paths through a hub or other similar device provided on a home network, or via communications network 614. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 616 to access content. Specifically, within a home, users of user television equipment 602 and user computer equipment 604 may access the media guidance application to navigate among and locate desirable content. Users may also access the media guidance application outside of the home using wireless user communications devices 606 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 614. These cloud resources may include one or more content sources 616 and one or more media guidance data sources 618. In addition or in the alternative, the remote computing sites may include other user equipment devices, such as user television equipment 602, user computer equipment 604, and wireless user communications device 606. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 604 or wireless user communications device 606 having content capture feature. Alternatively, the user can first transfer the content to a user equipment device, such as user computer equipment 604. The user equipment device storing the content uploads the content to the cloud using a data transmission service on communications network 614. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same.

The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 5.

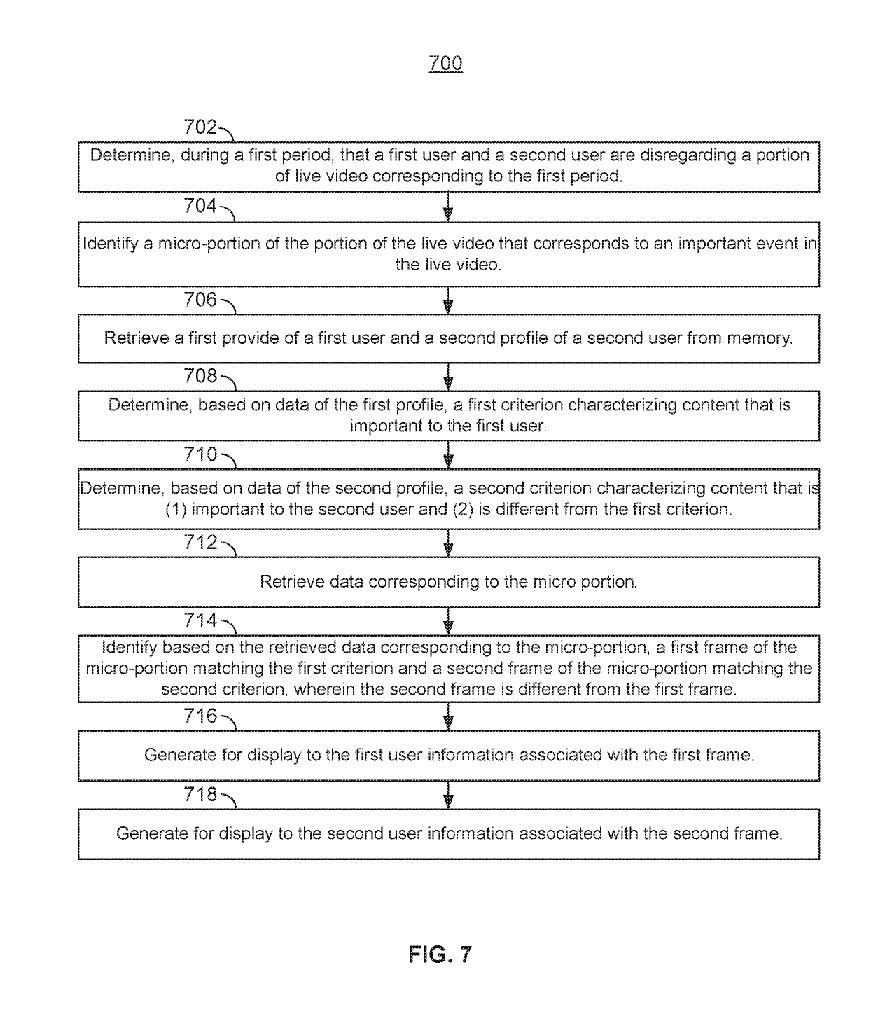

FIG. 7 Is a flowchart of illustrative steps for notifying different users about missed content by tailoring catch-up content to each different user in accordance with some embodiments of the disclosure. It should be noted that process 700 or any step thereof could be performed on, or provided by, any of the devices shown in FIGS. 1-2 and 4-6. For example, process 700 may be executed by control circuitry 504 (FIG. 5) as instructed by control circuitry 504 implemented on user equipment 602, 604, and/or 606 (FIG. 6), 106, 124, and/or 128 (FIG. 1), and/or 200 (FIG. 2) in order to notify different users about missed content by tailoring catch-up content to each different user. In addition, one or more steps may be incorporated into or combined with one or more steps of any other process or embodiment.

Process 700 begins at 702, where the media guidance application implemented on user equipment 106 and/or 200 executed by control circuitry 504 determines, during a first period, that a first user (e.g., user 112) and a second user (e.g., user 118) are disregarding a portion of live video (e.g., live video 222) corresponding to the first period. For example, control circuitry 504 may generate for display on display 512 of user equipment 106, 128, 124 and/or 200 a portion of live video (e.g., live video 222) received from media content source 616 via communications network 614. Control circuitry 504 may determine, using user input interface 510 that a first user and a second user are disregarding the live media (e.g., live video 222). For example, user equipment user equipment 106, 128, 124 and/or 200 may optionally comprise a camera accessible to control circuitry 504 via user input interface 510. Control circuitry 304 may determine, using the camera, that the first user and the second user are not visible within a visual field of the camera. In another example, control circuitry 504 may determine that a second device (e.g., user equipment 124 and/or 128) associated with a first user and a third device (e.g., user equipment 124 and/or 128) associated with a second user are outside of a range of the media guidance application implemented on user equipment 106 and/or 200 executed by control circuitry 504.

For example, control circuitry 504 may determine, using wireless user communications device 606, that the second and the third device (e.g., user equipment 124 and/or 128) are not within a wireless communication range of control circuitry 504. The control circuitry 504 may determine that if the devices are outside of the range that the users are disregarding a portion of live video (e.g., live video 222). These are just exemplary examples of how control circuitry 504 may determine whether the first and the second user are disregarding the portion. Control circuitry 504 may perform any of the steps and methods above described above in relation to FIG. 1 and FIG. 2.

At 704, the media guidance application implemented on user equipment 106 and/or 200 executed by control circuitry 504 identifies a micro-portion of the portion of the live video (e.g., live video 222) that corresponds to an important event in the live video. For example, control circuitry 504 may retrieve from a database, such as media guidance data source 618, information corresponding to each frame of the live video. For example, control circuitry 504 may detect a flag identifying whether content in the frame is important. Control circuitry 504 may determine that the frame of the live video (e.g., live video 222) is important when control circuitry 504 determines that the flag is set. In another example control circuitry 504 may perform image processing on the frame to determine whether the frame corresponds to an important event type. Control circuitry 504 may determine that the frame is important if the frame matches the important event type.

At 706, the media guidance application implemented on user equipment 106 and/or 200 executed by control circuitry 504 retrieves a first profile of a first user and a second profile of a second user from memory (e.g., storage 508). For example, control circuitry 504 may retrieve from storage 508 or from media guidance data source 618 via communications network 614, data associated with the first and the second user profile. For example, control circuitry 504 may transmit a unique identifier associated with each user to the database and may retrieve data matching the unique identifier.

At 708, the media guidance application implemented on user equipment 106 and/or 200 executed by control circuitry 504 determines, based on data of the first profile, a first criterion characterizing content that is important to the first user. For example, control circuitry 504 may analyze the profile of the user to determine whether the user has identified favorite content, such as a favorite actor, favorite sports team, etc. If control circuitry 504 does not identify a setting for the favorite content, control circuitry 504 may analyze the users viewing history to determine if there is content that the user frequently consumes. If there is content frequently consumed by the user, control circuitry 504 may identify a characteristic, such as a main actress, of the content as the criterion.

At 710, the media guidance application implemented on user equipment 106 and/or 200 executed by control circuitry 504 determines, based on data of the second profile, a second criterion characterizing content that (1) is important to the second user and (2) is different from the first criterion. For example, as described above in relation to step 708, control circuitry 504 may analyze the second user profile to determine a criterion associated with content that is of interest to the user. Control circuitry 504 may compare the first criterion to the second criterion to determine whether the two criterions match. If the criterions match, control circuitry 504 may identify a same frame that is important to both the first user and the second user. In some embodiments, control circuitry 504 will identify an alternative second criterion not matching the first criterion in response to determining that the criterion match.

At 712, the media guidance application implemented on user equipment 106 and/or 200 executed by control circuitry 504 retrieves data corresponding to the micro-portion. For example, control circuitry 504 may transmit a query (e.g., via communications network 614) to a remote server, such as media guidance data source 618, to retrieve data describing content in the micro-portion. For example, control circuitry 504 may perform image processing to identify objects in frames of the micro-portion as described above. Control circuitry 504 may generate words describing the identified objects and may perform a search on media guidance data source 618 for further information pertaining to the identified objects. In some embodiments, control circuitry queries the database (e.g., media guidance data source 618) for information specifically about the live media. For example, control circuitry 504 may perform a search for an actor. Control circuitry 504 may filter all content about the actor that does not pertain to their role in the live media.

At 714, the media guidance application implemented on user equipment 106 and/or 200 executed by control circuitry 504 identifies, based on the retrieved data corresponding to the micro-portion (e.g., data retrieved from media guidance data source 618 via communications network 614), a first frame of the micro-portion (e.g., first frame 208) matching the first criterion and a second frame of the micro-portion (e.g., second frame 218) matching the second criterion, wherein the second frame is different from the first frame. For example, when the first criterion and the second criterion selected by control circuitry 504 are different, control circuitry 504 may identify a first frame (e.g., first frame 208) relevant to the first user, based on the criterion, and a second frame (e.g., second frame 218) relevant to the second user, based on the criterion. Control circuitry 504 may select the frame based on the identified objects in the frame matching objects associated with the criterion, as described above. In some embodiments, control circuitry 504 may match the criterion to metadata associated with frames of the micro-portion. For example, control circuitry 504 may determine that the first criterion is an actor name. Control circuitry 504 may search subtitles associated with the live media for a character corresponding to the actor and may determine that the frame is important when the frame comprises subtitles having the character's name.

At 716, the media guidance application implemented on user equipment 106 and/or 200 executed by control circuitry 504 generates for display (e.g., on display 512 of user equipment 106, 124, 128, 200, 602, 604, 606) to the first user information associated with the first frame (e.g., first frame 208). For example, control circuitry 504 may determine that the frame (e.g., first frame 208) comprises an character of interest to the user. Control circuitry 504 may identify information associated with the character's actions associated with the frame and may optionally generate for display a textual description (e.g., first frame description 210) of said actions to the user on display 512. For example, if the frame corresponds to a movie scene where lotto winners are announced, if the character of interest to the first user wins the lotto, control circuitry 504 may optionally generate for display to the first user text describing that the character won the lotto in the scene and may optionally generate for display the first frame that may be of interest to the user, such as a scene showing the character of interest to the first user elated by winning the lotto. In contrast, if control circuitry 504 determined that the second user likes a second character, one who did not win the lotto, control circuitry 504 may optionally generate for display to the second user text describing that in the scene the character of interest to the second user did not win the lotto.

At 718, the media guidance application implemented on user equipment 106 and/or 200 executed by control circuitry 504 generates for display to the second user (e.g., on display 512 of user equipment 106, 124, 128, 200, 602, 604, 606) information associated with the second frame. Following from the previous example, if control circuitry 504 determines that the character of interest to the second user does not win the lotto, control circuitry 504 may optionally generate for display a frame showing the character of interest to the second user upset at the lotto drawings and may optionally generate for display text describing that the character did not win the lotto in the scene.

In some embodiments, control circuitry 504 may generate for display the information associated with either the first or the second frame on a second device associated with the first or the second user respectively (e.g., user equipment 124 and/or 128). For example, control circuitry 504 may transmit data to the user equipment, such as a cell phone associated with the user, comprising the information and may prompt the user equipment to generate a notification with the information.

It is contemplated that the steps or description of FIG. 7 may be used with any other embodiment of this disclosure. In addition, the steps and descriptions described in relation to FIG. 7 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-2, 5-6 could be used to perform one or more of the steps in FIG. 7.

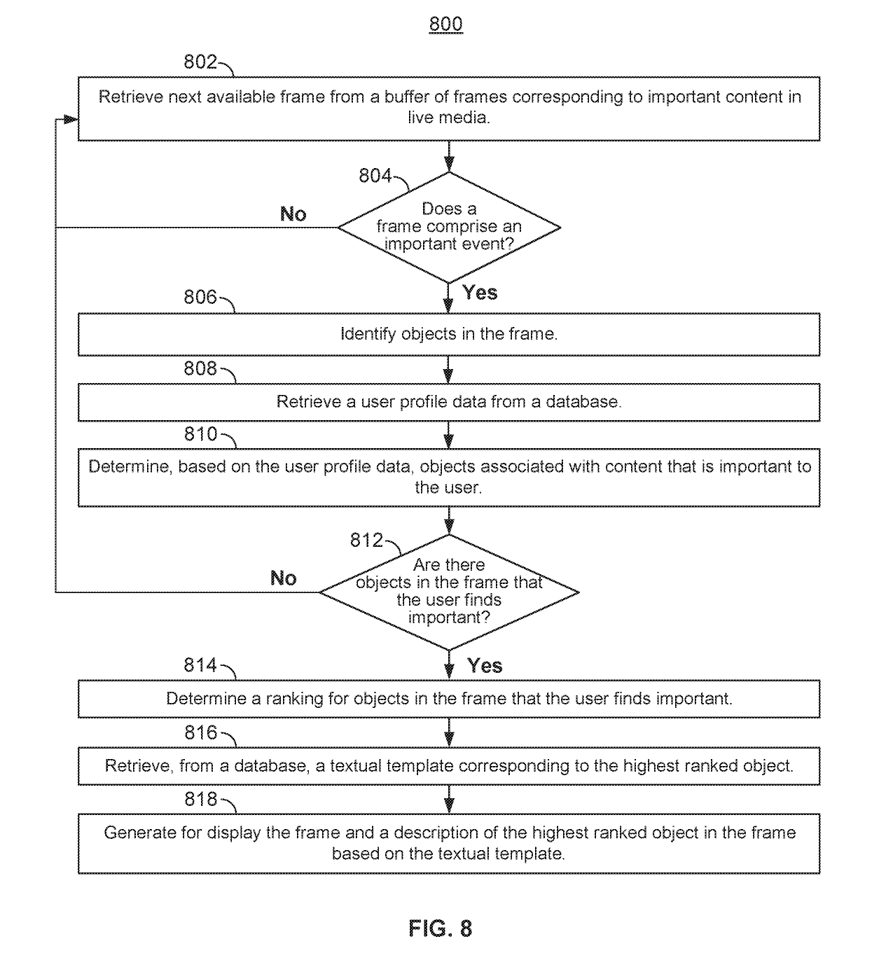

FIG. 8. Is a flowchart of illustrative steps for tailoring catch-up content to a user in accordance with some embodiments of the disclosure. It should be noted that process 700 or any step thereof could be performed on, or provided by, any of the devices shown in FIGS. 1-2, 5-6. For example, process 800 may be executed by control circuitry 504 (FIG. 5) as instructed by control circuitry 504 implemented on user equipment 602, 604, and/or 606 (FIG. 6), 106, 124, and/or 128 (FIG. 1), and/or 200 (FIG. 2) in order to determine how to provide search results to the user. In addition, one or more steps of process 800 may be incorporated into or combined with one or more steps of any other process or embodiment.

Process 800 begins at 802, where the media guidance application implemented on user equipment 106 and/or 200 executed by control circuitry 504 retrieves a next available frame from a buffer of frames (e.g., storage 508) corresponding to important content in live media (e.g., live media 222). For example, control circuitry 504 may retrieve a frame from an output display buffer, such as storage 508, for a frame that is to be generated for display on display 512 of user equipment 106 and/or 200. Control circuitry 508 may in some examples, retrieve the frame before the frame is decoded or may retrieve the frame after it was displayed and is being discarded from the display buffer (e.g., storage 508). In some embodiments, control circuitry 504 comprises a special buffer or location in memory, such as storage 508, for temporarily storing frames of the live media until control circuitry 504 can process said frame.

At 804, the media guidance application implemented on user equipment 106 and/or 200 executed by control circuitry 504 determines whether the frame comprises an important event. For example, control circuitry 504 may retrieve metadata associated with the frame (e.g., via communications network 614 from media content source 616 or media guidance data source 618) and determine whether a flag is set in the metadata which identifies the content as important. In some embodiments control circuitry 504 determines if the frame comprises an important event based on detecting objects in the frame as described above. If control circuitry 504 determines that the frame has important content, control circuitry 504 proceeds to step 806. If control circuitry 504 determines that the frame does not have important content, control circuitry 504 returns to step 802.

At 806, the media guidance application implemented on user equipment 106 and/or 200 executed by control circuitry 504 identifies objects in the frame. For example, control circuitry 504 may use an image processing algorithm to identify objects in the frame, such as a frame of live video 222. Control circuitry 504 may store an array comprising each object identified in each frame. The array may be stored in storage 508. In some embodiments, control circuitry 504 may identify the objects in the frame based on data retrieved about the frame. For example, control circuitry 504 may retrieve data (e.g., via communications network 614 from media content source 616 or media guidance data source 618) about each frame comprising a listing of objects in the frame.

At 808, the media guidance application implemented on user equipment 106 and/or 200 executed by control circuitry 504 retrieves a user profile from a database. As described above, control circuitry 504 may identify a user based on a user login, facial recognition or any other user identification method. Control circuitry 504 may transmit an identifier of the user to a database, such as media guidance database 618, and may retrieve user profile data corresponding to the identity of the user.

At 810, the media guidance application implemented on user equipment 106 and/or 200 executed by control circuitry 504 determines, based on the user profile data, objects associated with content that is important to the user. For example, control circuitry 504 may generate a criterion based on the user profile associated with content of interest to the user as described above. Control circuitry 504 may identify objects associated with the criterion that are important to the user. For example, control circuitry 504 may query a database, such as media guidance data source 618 for a listing of objects associated with the criterion.

At 812, the media guidance application implemented on user equipment 106 and/or 200 executed by control circuitry 504 determines whether there are objects in the frame (e.g., a frame of live vide 222) that the user finds important.

For example, control circuitry 504 may identify objects in the frame as described above. Control circuitry 504 may compare the objects that are identified in the frame to objects from a list of objects identified in step 810. If control circuitry 504 determines that the objects of the frame match objects that match the criterion, control circuitry 504 may store the frame in memory (e.g., storage 508), so that the frame can be rendered at a later time for the user, and proceeds to 814. If control circuitry 504 determines that objects in the frame do not match objects of interest to the user, control circuitry 504 proceeds to 802.

At 814, the media guidance application implemented on user equipment 106 and/or 200 executed by control circuitry 504 determines a ranking for objects in the frame that the user finds important. For example, control circuitry 504 may determine a ranking based on how large objects of interest to the user appear in the frame. For example, if control circuitry 504 determines that the user likes two actors equally, and if control circuitry 504 determines that the frame comprises both actors, control circuitry 504 may compute a number of pixels within the frame corresponding to each actor. In another example, control circuitry 504 may determine that a user likes a first actor better than a second actor. Control circuitry 504 may therefore rank a first object corresponding to the first actor higher than the a second object corresponding to the second actor. Control circuitry 504 may optionally generate for display text describing the important event in relation to the highest ranked object (e.g., the first actor)a display, such as display 512 of user equipment 106, 124, 128, 200, 602, 604, and/or 606.

At 816, the media guidance application implemented on user equipment 106 and/or 200 executed by control circuitry 504 optionally retrieves, from a database, such as media guidance data source 618, a textual template corresponding to the highest ranked object. For example, control circuitry 504 may transmit a query to the media guidance data source 618 text associated with the largest object, such at the first actor. Control circuitry 504 may receive a response to the query describing information associated with the actor. In some embodiments, control circuitry 504 may need to generate additional queries to the same or additional databases to fill in all information for the template. For example, the template may require a description of the actor's outfit. Control circuitry 504 may perform image processing on the frame to detect the user's outfit and may input the information about the outfit into the template.

At 818, the media guidance application implemented on user equipment 106 and/or 200 executed by control circuitry 504 optionally generates for display the frame and a description of the highest ranked object in the frame based on the textual template. For example, control circuitry 504 may generate for display to a first user a first description (e.g., first frame description 210) based on the template and a first frame (e.g., first frame 208) corresponding to a first actor of interest to the first user. Control circuitry 504 may, for the same important content, generate for display to a second user a second frame (e.g., second frame 218) and a second description (e.g., second frame description 220) based on the template corresponding to a second actor of interest to the second user.

It is contemplated that the steps or description of FIG. 8 may be used with any other embodiment of this disclosure. In addition, the steps and descriptions described in relation to FIG. 8 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 1-2, 5-6 could be used to perform one or more of the steps in FIG. 8.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for notifying different users about content from live video that the different users missed by tailoring important catch-up segments to each different user, the method comprising:
determining, during a first period, that a first user and a second user are disregarding a portion of live video corresponding to the first period;
identifying a micro-portion of the portion of the live video that corresponds to an important event in the live video;
retrieving a first profile of a first user and a second profile of a second user from memory;
determining, based on data of the first profile, a first criterion characterizing content that is important to the first user;
determining, based on data of the second profile, a second criterion characterizing content that (1) is important to the second user and (2) is different from the first criterion;
retrieving data corresponding to the micro-portion;
identifying, based on the retrieved data corresponding to the micro-portion, a first frame of the micro-portion matching the first criterion and a second frame of the micro-portion matching the second criterion, wherein the second frame is different from the first frame;
generating for display to the first user information associated with the first frame; and
generating for display to the second user information associated with the second frame.

2. The method of claim 1, wherein identifying the micro-portion corresponding to the important event in the live video comprises:
determining a respective type of each micro-portion of the portion;
retrieving, from a database, a set of popular types of micro-portions;
comparing each respective type to types of the set of popular types to determine whether a micro-portion of the portion matches a popular type from the set; and
determining that the micro-portion of the portion corresponds to the important event in the live video if the micro-portion matches the popular type from the set.

3. The method of claim 1, wherein identifying the first frame of the micro-portion matching the first criterion and the second frame of the micro-portion matching the second criterion comprises:
identifying a first plurality of objects associated with the first criterion and a second plurality of objects associated with the second criterion;
performing object recognition on each respective frame of a plurality of frames associated with the micro-portion to identify a respective plurality of objects associated with each respective frame;
selecting the first frame in response to determining that the first frame is associated with the first plurality of objects; and
selecting the second frame in response to determining that the second frame is associated with the second plurality of objects.

4. The method of claim 3, wherein the plurality of frames associated with the micro-portion is a first plurality of frames, and wherein selecting the first frame in response to determining that the first frame is associated with the first plurality of objects comprises:
identifying, from the first plurality of frames, a second plurality of frames each comprising an object matching the first plurality of objects;
ranking each respective frame of the second plurality of frames based on a respective amount of objects in the respective frame matching the first plurality of objects; and
selecting the first frame in response to determining that the first frame has a highest respective amount of objects matching the first plurality of objects with respect to each frame of the second plurality of frames.

5. The method of claim 3, further comprising:
computing a respective amount of pixels corresponding to each object of the first plurality of objects within the first frame;
based on the respective amount of pixels, identifying a largest object, from the first plurality of objects, corresponding to a highest respective percentage of pixels;
retrieving, from a database, a textual template associated with the largest object; and
generating for display text describing the largest object based on the retrieved textual template.

6. The method of claim 1, wherein identifying the micro-portion of the portion corresponding to the important event in the live video comprises:
retrieving a frame of the live video generated for display during the portion;
analyzing the frame using an image processing algorithm to determine whether the frame matches an image processing rule; and
determining that the frame corresponds to the important event when the frame matches the image processing rule.

7. The method of claim 1, wherein the portion of the live video is generated for display by a first user equipment, and wherein determining that the first user and the second user are disregarding a portion of live video comprises:
identifying a second user equipment associated with the first user and a third user equipment associated with the second user;
determining, at a first time, before the first period, that the second user equipment and the third user equipment are within a threshold maximum distance from the first user equipment;
determining, at a second time, during the first period, that the second user equipment and the third user equipment are greater than the threshold maximum distance away from the first user equipment; and
determining that the first user and the second user are disregarding the live video at the second time in response to determining that the second user equipment and the third user equipment are greater than the threshold maximum distance away from the first user equipment.

8. The method of claim 7, further comprising:
generating for display on the second user equipment the information associated with the first frame in response to determining, at a third time later than the second time, that the second user equipment is within the threshold maximum distance away from the first user equipment; and
generating for display on the third user equipment the information associated with the second frame in response to determining that the third user equipment is within the threshold maximum distance away from the first user equipment.

9. The method of claim 7, further comprising:
generating for display on the second user equipment, at the second time, the information associated with the first frame in response to determining that the second user equipment is greater than the threshold maximum distance away from the first user equipment.

10. The method of claim 1, wherein the live video is generated for display by the first user equipment, and wherein the method further comprises:
detecting, using a camera associated with the first user equipment, a first gaze point corresponding to the first user and a second gaze point corresponding to the second user relative to the first user equipment; and
determining that the first user and the second user are disregarding the live video in response to determining that the first gaze point and the second gaze point do not correspond to the first user equipment.

11. A system comprising control circuitry configured to notify different users about content from live video that the different users missed by tailoring important catch-up segments to each different user, wherein the control circuitry is configured to:
determine, during a first period, that a first user and a second user are disregarding a portion of live video corresponding to the first period;
identify a micro-portion of the portion of the live video that corresponds to an important event in the live video;
retrieve a first profile of a first user and a second profile of a second user from memory;
determine, based on data of the first profile, a first criterion characterizing content that is important to the first user;
determine, based on data of the second profile, a second criterion characterizing content that (1) is important to the second user and (2) is different from the first criterion;
retrieve data corresponding to the micro-portion;
identify, based on the retrieved data corresponding to the micro-portion, a first frame of the micro-portion matching the first criterion and a second frame of the micro-portion matching the second criterion, wherein the second frame is different from the first frame;
generate for display to the first user information associated with the first frame; and
generate for display to the second user information associated with the second frame.

12. The system of claim 11, wherein the control circuitry is further configured, when identifying the micro-portion corresponding to the important event in the live video, to:
determine a respective type of each micro-portion of the portion;
retrieve, from a database, a set of popular types of micro-portions;
compare each respective type to types of the set of popular types to determine whether a micro-portion of the portion matches a popular type from the set; and
determine that the micro-portion of the portion corresponds to the important event in the live video if the micro-portion matches the popular type from the set.

13. The system of claim 11, wherein the control circuitry is further configured, when identifying the first frame of the micro-portion matching the first criterion and the second frame of the micro-portion matching the second criterion, to:
identify a first plurality of objects associated with the first criterion and a second plurality of objects associated with the second criterion;
perform object recognition on each respective frame of a plurality of frames associated with the micro-portion to identify a respective plurality of objects associated with each respective frame;
select the first frame in response to determining that the first frame is associated with the first plurality of objects; and
select the second frame in response to determining that the second frame is associated with the second plurality of objects.

14. The system of claim 13, wherein the plurality of frames associated with the micro-portion is a first plurality of frames, and wherein the control circuitry is further configured, when selecting the first frame in response to determining that the first frame is associated with the first plurality of objects, to:
identify, from the first plurality of frames, a second plurality of frames each comprising an object matching the first plurality of objects;
rank each respective frame of the second plurality of frames based on a respective amount of objects in the respective frame matching the first plurality of objects; and
select the first frame in response to determining that the first frame has a highest respective amount of objects matching the first plurality of objects with respect to each frame of the second plurality of frames.

15. The system of claim 13, wherein the control circuitry is further configured to:
compute a respective amount of pixels corresponding to each object of the first plurality of objects within the first frame;
based on the respective amount of pixels, identify a largest object, from the first plurality of objects, corresponding to a highest respective percentage of pixels;
retrieve, from a database, a textual template associated with the largest object; and
generate for display text describing the largest object based on the retrieved textual template.

16. The system of claim 11, wherein the control circuitry is further configured, when identifying the micro-portion of the portion corresponding to the important event in the live video, to:
retrieve a frame of the live video generated for display during the portion;
analyze the frame using an image processing algorithm to determine whether the frame matches an image processing rule; and
determine that the frame corresponds to the important event when the frame matches the image processing rule.

17. The system of claim 11, wherein the portion of the live video is generated for display by a first user equipment, and wherein the control circuitry is further configured, when determining that the first user and the second user are disregarding a portion of live video, to:
identify a second user equipment associated with the first user and a third user equipment associated with the second user;
determine, at a first time, before the first period, that the second user equipment and the third user equipment are within a threshold maximum distance from the first user equipment;
determine, at a second time, during the first period, that the second user equipment and the third user equipment are greater than the threshold maximum distance away from the first user equipment; and
determine that the first user and the second user are disregarding the live video at the second time in response to determining that the second user equipment and the third user equipment are greater than the threshold maximum distance away from the first user equipment.

18. The system of claim 17, wherein the control circuitry is further configured to:
generate for display on the second user equipment the information associated with the first frame in response to determining, at a third time later than the second time, that the second user equipment is within the threshold maximum distance away from the first user equipment; and
generate for display on the third user equipment the information associated with the second frame in response to determining that the third user equipment is within the threshold maximum distance away from the first user equipment.

19. The system of claim 17, wherein the control circuitry is further configured to:
generate for display on the second user equipment, at the second time, the information associated with the first frame in response to determining that the second user equipment is greater than the threshold maximum distance away from the first user equipment.

20. The system of claim 11, wherein the control circuitry is further configured to:
generate for display the live video on the first user equipment;
detect, using a camera associated with the first user equipment, a first gaze point corresponding to the first user and a second gaze point corresponding to the second user relative to the first user equipment; and
determine that the first user and the second user are disregarding the live video in response to determining that the first gaze point and the second gaze point do not correspond to the first user equipment.

21-50. (canceled)
